(19) United States
(12) Patent Application Publication
(10) Pub. No.: US 2008/0218554 A1
(43) Pub. Date: Sep. 11, 2008

(54) LIQUID EJECTION APPARATUS AND LIQUID EJECTION SURFACE MAINTENANCE METHOD

(76) Inventor: Hiroshi INOUE, Kanagawa-ken (JP)

Correspondence Address: BIRCH STEWART KOLASCH & BIRCH, PO BOX 747, FALLS CHURCH, VA, 22040-0747, US

(21) Appl. No.: 12/043,693

(22) Filed: Mar. 6, 2008

(30) Foreign Application Priority Data
Mar. 9, 2007 (JP) 2007-060716

(51) Int. Cl. B41J 2/165; B41J 29/38

(52) U.S. Cl. 347/33; 347/17; 347/22

(57) ABSTRACT

A liquid ejection apparatus includes: a liquid ejection head which includes a nozzle ejecting liquid, a pressure chamber connected to the nozzle and arranged in a liquid ejection surface of the liquid ejection head, and a pressure application device applying pressure to the liquid inside the pressure chamber; an internal pressure adjustment device which adjusts an internal pressure of the liquid ejection head; and a pressure control device which controls the internal pressure adjustment device and the pressure application device so as to spread the liquid over the liquid ejection surface of the liquid ejection head. The internal pressure adjustment device adjusts the internal pressure of the liquid ejection head to a positive pressure so as to still hold the liquid on the nozzle while protruding the liquid from the liquid ejection surface. The pressure application device then applies the pressure to the liquid inside the pressure chamber for a pressure application duration so as not to cause the liquid to be ejected from the nozzle but to flow out the liquid from the nozzle onto the liquid ejection surface, while the internal pressure adjustment device is adjusting the internal pressure to the positive pressure. The pressure application device then stops applying the pressure to the liquid inside the pressure chamber after the pressure application duration, while the internal pressure adjustment device is adjusting the internal pressure to the positive pressure.

### BACKGROUND OF THE INVENTION

1. Field of the Invention

The present invention relates to a liquid ejection apparatus and a liquid ejection surface maintenance method, and more particularly, to technology for cleaning the liquid ejection surface of a liquid ejection head which ejects liquid droplets from nozzles.

2. Description of the Related Art

In general, an inkjet recording apparatus which forms a desired image by ejecting ink droplets from an inkjet head onto a recording medium has been known as a generic image forming apparatus. In an inkjet recording apparatus, ink is liable to adhere to the ink ejection surface of the inkjet head, and if residual ink of this kind solidifies, then it can cause ejection abnormalities, such as abnormalities in the ink ejection volume or abnormalities in the ejection direction. Hence, it is necessary to carry out periodic maintenance (cleaning) of the ink ejection surface of the inkjet head. One method of cleaning the ink ejection surface involves placing a blade on the ink ejection surface of the inkjet head and wiping and removing the ink adhering to the ink ejection surface. In performing wiping operation by means of a blade, it is possible readily to remove ink in liquid state which has adhered to the ink ejection surface, but it is difficult to remove ink which has cured to a certain extent, and it is not possible to obtain a satisfactory cleaning effect. Supposing that wiping is carried out by increasing the force with which the blade is pressed against the ink ejection surface, then although it is possible to remove the cured ink adhering to the ink ejection surface to a certain extent, there is a possibility that the liquid-phobic film formed on the ink ejection surface will be damaged and that ejection abnormalities will be caused by the resulting defects in the liquid-phobic film. In order to resolve problems of this kind, various methods have been proposed for maintaining the ink ejection surface of an inkjet head.

Japanese Patent Application Publication No. 7-096604 discloses that the position of a cleaning member is determined, nozzles corresponding to the position of the cleaning member and nozzles adjacent to the cleaning member are selected, and a drive signal of a level sufficient to wet the liquid ejection surface of the recording head is applied to the piezoelectric vibrating elements that are provided for the selected nozzles. The ink is thereby caused to flow out from the selected nozzles onto the ink ejection surface and wet the ink ejection surface in the vicinity of the selected nozzles. In this state, cleaning of the ink ejection surface is carried out by means of the cleaning member.

Japanese Patent Application Publication No. 2004-291618 discloses that a purge pump applies pressure to the ink inside pressure chambers so as to protrude the ink from the liquid ejection surface, and that a cleaning member makes contact with the liquid ejection surface (i.e., a surface of the nozzle plate) while sliding over the liquid ejection surface in the state where the purge pump applies the pressure to the ink inside the pressure chambers.

However, in the invention described in Japanese Patent Application Publication No. 7-096604, although it is possible to flow out the ink from the selected nozzles onto a very small region (regions in the vicinity of the selected nozzles) of the ink ejection surface, it is difficult to spread the ink to regions relatively distant from the selected nozzles, and it is not possible completely to remove adhering material, such as cured ink, which is attached to a portion that is relatively distant from the selected nozzles, due to the creation of mist, or the like. Moreover, in the case of an inkjet head including a plurality of nozzles, there is a concern that the ink is not flowed out uniformly from each of the selected nozzles even when the same drive signal is applied to the piezoelectric vibration elements, since the behavior of the ink (ink meniscus) inside nozzles is not uniform in all of the nozzles due to the variations in the flow channel resistances of the respective nozzles, and the variation in the ink viscosity depending on the use frequency of the respective nozzles, the humidity and temperature conditions, and the like. If the ink is not flowed out from the nozzles in a uniform fashion, then there is a possibility that there will remain regions that cannot be cleaned.

In the invention described in Japanese Patent Application Publication No. 2004-291618, it is possible to remove adhering material, such as cured ink, which is attached to the nozzle openings and the vicinity of the nozzle openings. However, since the ink is not present in portions other than the nozzle openings and the vicinity of the nozzle openings, there exist regions where cleaning is performed without the cleaning member making contact with the ink on the ink ejection surface. Hence, there is a possibility that the liquid-phobic surface provided on the nozzle plate may be damaged, in addition to which it is not possible to remove the adhering material that adheres to regions distant from the nozzles. Moreover, in the case of an ejection head having a plurality of nozzles, variations occur in the volume (ink projection amount) of ink that projects from the nozzles, due to variations in the flow channel resistances of the nozzles, and variations in the viscosities of the ink inside the nozzles. Therefore, in pressurizing the ink inside the pressure chambers by means of the purge pump, the pressure is required to be adjusted so as to apply sufficient pressure to the ink inside the nozzle that is liable to have the smallest ink projection amount, and therefore in nozzles having a relatively small flow channel resistance, the ink projection amount will be relatively large and there is a possibility that ink will leak out (drip from the nozzle), depending on the nozzle. If ink leaks out from a particular nozzle, then the pressure generated by the purge pump is not applied to the other nozzles, and it becomes impossible to make the ink project uniformly from the plurality of nozzles.

### SUMMARY OF THE INVENTION

The present invention has been contrived in view of these circumstances, an object thereof being to provide a liquid ejection apparatus and a liquid ejection surface maintenance method, whereby ink which has been flowed out from nozzles onto the liquid ejection surface can be caused to spread uniformly to positions which are distant from the nozzles, adhering material which is attached to the liquid ejection surface can be removed reliably and efficiently, and damage to the liquid-phobic film (also referred to as liquid repelling film) formed on the nozzles and the liquid ejection surface is prevented.

In order to attain the aforementioned object, the present invention is directed to a liquid ejection apparatus, comprising: a liquid ejection head which includes a nozzle ejecting liquid, a pressure chamber connected to the nozzle and arranged in a liquid ejection surface of the liquid ejection head, and a pressure application device applying pressure to the liquid inside the pressure chamber; an internal pressure adjustment device which adjusts an internal pressure of the liquid ejection head; and a pressure control device which controls the internal pressure adjustment device and the pressure application device so as to spread the liquid over the liquid ejection surface of the liquid ejection head, wherein: the internal pressure adjustment device adjusts the internal pressure of the liquid ejection head to a positive pressure so as to still hold the liquid on the nozzle while protruding the liquid from the liquid ejection surface; the pressure application device then applies the pressure to the liquid inside the pressure chamber for a pressure application duration so as not to cause the liquid to be ejected from the nozzle but to flow out the liquid from the nozzle onto the liquid ejection surface, while the internal pressure adjustment device is adjusting the internal pressure to the positive pressure; and the pressure application device then stops applying the pressure to the liquid inside the pressure chamber after the pressure application duration, while the internal pressure adjustment device is adjusting the internal pressure to the positive pressure.

In this aspect of the present invention, a pressure within a range that does not cause the liquid to be ejected from the nozzle is applied, while maintaining a state where the liquid inside the nozzle is caused to protrude from the liquid ejection surface but to be still held at the nozzle. Therefore, even when there is variation in the amount of liquid that protrude from the liquid ejection surface, due to variations in the flow channel resistances of the nozzles and the pressure chambers, by combining the application of pressure by the pressure application device with the adjustment of internal pressure by the internal pressure adjustment device, it is possible to make the liquid bleed out reliably from the nozzle, and it is also possible to cause the ink which has bled out from the nozzle to spread uniformly on the liquid ejection surface to positions which are distant from the nozzle.

Moreover, by causing the liquid which has bled out from the nozzles to spread over the liquid ejection surface by maintaining the internal pressure of the liquid ejection head at a positive pressure, it is possible to make the solvent of the liquid come into contact with the adhering material (i.e., liquid in the form of a mist, or solidified liquid, or the like) which has adhered to the liquid ejection surface, and therefore the adhering material can be removed easily.

For the internal pressure adjustment device, it is possible to use a pressure changeable apparatus such as a pump, and it is also possible to adopt a mode in which a sub tank that is opening to the atmosphere is provided in the liquid ejection head, and the internal pressure of the liquid ejection head is adjusted by changing the liquid head pressure differential between the sub tank and the liquid ejection head.

In one mode, a piezoelectric element which applies an ejection force to the liquid inside the pressure chamber is used as the pressure application device. In a mode which uses the piezoelectric element for ejection driving as the pressure application device, it is possible to apply pressure to the liquid inside the pressure chamber by applying a non-ejection drive signal, which is a drive signal within a range that does not cause the liquid inside the pressure chamber to be ejected from the nozzle.

In other words, the “non-ejection drive signal” means a drive signal having a voltage within a range which is enough to move from the edge of the nozzle onto the liquid ejection surface the clip point of the meniscus (i.e., gas-liquid interface between the atmosphere and the ink inside the nozzle) protruding from the liquid ejection surface, but which cannot cause the liquid inside the nozzle to form into a droplet and be ejected from the nozzle.

The liquid ejection surface indicates a surface of the liquid ejection head where the nozzle openings are arranged, and the liquid ejection surface opposes the recording medium on which liquid droplets ejected from the nozzles are deposited.

Preferably, the pressure application duration is not less than 0.1 seconds and less than 10 seconds.

In this aspect of the present invention, by applying pressure to the liquid inside the pressure chamber by means of the pressure application device, it is possible to cause the clip point of the liquid (the position where the meniscus boundary is held) to move instantaneously from inside the nozzle toward (onto) the liquid ejection surface, and therefore it is sufficient for the pressure application duration of the pressure application device to be a short time, namely, a time equal to or greater than 0.1 seconds and less than 10 seconds.

Desirably, if there is increased viscosity in the liquid inside the nozzle, then the pressure application duration should be increased in comparison with a case where there is no increase in viscosity.

Preferably, the liquid ejection apparatus further comprises: an information acquisition device which acquires information including at least one of a type of the liquid, use frequency of the liquid ejection head, temperature of the liquid ejection head, and ambient humidity; and a viscosity judgment device which judges whether or not a viscosity of the liquid inside the liquid ejection head is higher than a reference viscosity, in accordance with the information acquired by the information acquisition device, wherein when the viscosity judgment device judges that the viscosity in the liquid ejection head is higher than the reference viscosity, the pressure control device increases the pressure application duration.

In this aspect of the present invention, if the viscosity of the liquid inside the nozzle is raised, then the pressure application duration by the pressure application device is increased, and therefore the clip point of the liquid can be moved reliably from inside the nozzle toward the liquid ejection surface.

Preferably, the liquid ejection apparatus further comprises a liquid collection device which collects the liquid that has been spread over the liquid ejection surface.

In this aspect of the present invention, by collecting the liquid which has spread onto the liquid ejection surface, the adhering material that has become attached to the liquid ejection surface is removed.

A desirable mode is one where, when collecting the liquid on the liquid ejection surface by means of the liquid collection device, the internal pressure of the liquid ejection head is changed from a positive pressure to atmospheric pressure or negative pressure.

Furthermore, a desirable mode is one where an expulsion device is provided for expelling the liquid collected by the liquid collection device, to the exterior of the liquid ejection head.

For the liquid collection device, it is suitable to use a wiping device (for example, a wiping blade) which wipes and removes the liquid on the liquid ejection surface by making contact with the liquid ejection surface.

Preferably, the liquid ejection apparatus further comprises: a standby duration setting device which sets a standby duration; and a measurement device which measures an elapsed time from a time when the pressure application device stops applying the pressure to the liquid inside the pressure chamber, wherein: the liquid collection device includes a wiping member which makes contact with the liquid ejection surface while wiping the liquid ejection surface; the pressure control device controls the internal pressure adjustment device to change the internal pressure of the liquid ejection head from the positive pressure to an atmospheric pressure, when the elapsed time measured by the measurement device reaches the standby duration set by the standby duration setting device; and the wiping device wipes and removes from the liquid ejection surface the liquid that has been spread over the liquid ejection surface, while the internal pressure adjustment device is adjusting the internal pressure of the liquid ejection head to the atmospheric pressure.

In this aspect of the present invention, since the wiping and removal of liquid by the wiping member is started when a prescribed standby duration has elapsed after the end of pressurization by the pressure application device, then it is possible for the liquid to spread on the liquid ejection surface including regions distant from the nozzles, and therefore a “wet wiping” action can be achieved in the wiping and removal of the liquid by the wiping member. The wear and deterioration of the wiping member and/or the liquid ejection surface is thus prevented. Furthermore, since the liquid on the liquid ejection surface is wiped and removed in a state where the internal pressure of the liquid ejection head has been changed to the atmospheric pressure, then the bleeding out of the liquid from the nozzles is stopped, and further wetting and spreading of the liquid on the liquid ejection surface is prevented, thereby preventing the liquid from falling off (dripping) from the liquid ejection surface. Moreover, the liquid that has flowed out is prevented from flowing back into the nozzles, and gas bubbles are prevented from infiltrating into the nozzles during the wiping operation.

Preferably, the liquid ejection apparatus further comprises: a standby duration setting device which sets a standby duration; and a measurement device which measures an elapsed time from a time when the pressure application device stops applying the pressure to the liquid inside the pressure chamber, wherein the pressure control device controls the internal pressure adjustment device to change the internal pressure of the liquid ejection head from the positive pressure to a negative pressure so that the liquid having been spread over the liquid ejection surface is collected into the nozzle, when the elapsed time measured by the measurement device reaches the standby duration set by the standby duration setting device.

In this aspect of the present invention, a wiping member is not necessary for collecting the liquid which has spread over the liquid ejection surface.

A desirable mode is one where preliminary ejection is carried out in order to expel the liquid and adhering material from the nozzles, after collecting the liquid in the nozzles and the adhering material that is collected into the nozzles together with the liquid.

Preferably, the liquid ejection head includes at least two nozzle blocks each having at least one nozzle; the internal pressure adjustment device is provided for each of the at least two nozzle blocks; and the pressure control device controls the internal pressure adjustment device and the pressure application device for each of the at least two nozzle blocks so that the liquid is flowed out onto the liquid ejection surface from the at least one nozzle, and the liquid is then spread over the liquid ejection surface.

In this aspect of the present invention, when a mode in which the pressure application device also serves as piezoelectric elements for ejection driving is adopted, then a non-ejection drive signal is applied independently to each of the nozzle blocks and therefore it is possible to reduce the maximum power consumption for applying the non-ejection drive signal.

In order to attain the aforementioned object, the present invention is also directed to a liquid ejection surface maintenance method of maintaining a liquid ejection surface of a liquid ejection head which includes: a nozzle ejecting liquid and a pressure chamber connected to the nozzle, the liquid ejection surface maintenance method comprising the steps of: adjusting an internal pressure of the liquid ejection head to a positive pressure so as to still hold the liquid on the nozzle while protruding the liquid from the liquid ejection surface; then applying pressure to the liquid inside the pressure chamber for a pressure application duration so as not to cause the liquid to be ejected from the nozzle but to flow out the liquid from the nozzle onto the liquid ejection surface, while the internal pressure is being adjusted to the positive pressure; and then stopping applying the pressure to the liquid inside the pressure chamber after the pressure application duration, while the internal pressure is being adjusted to the positive pressure, wherein the liquid is thereby spread over the liquid ejection surface.

A desirable mode is one in which the liquid that has spread over the liquid ejection surface is collected after changing the internal pressure of the liquid ejection head and stopping the liquid from flowing out from the nozzles onto the liquid ejection surface.

Preferably, the liquid ejection surface maintenance method further comprises the steps of: setting a standby duration; measuring an elapsed time from a time when application of the pressure to the liquid inside the pressure chamber is stopped; changing the internal pressure of the liquid ejection head from the positive pressure to an atmospheric pressure, when the measured elapsed time reaches the set standby duration; and wiping and removing from the liquid ejection surface the liquid that has been spread over the liquid ejection surface, while the internal pressure of the liquid ejection head is being adjusted to the atmospheric pressure.

A desirable mode is one where the internal pressure of the liquid ejection head is changed to a negative pressure after wiping and removing the liquid which has spread over the liquid ejection surface.

Preferably, the liquid ejection surface maintenance method further comprises the steps of: setting a standby duration; measuring an elapsed time from a time when application of the pressure to the liquid inside the pressure chamber is stopped; and changing the internal pressure of the liquid ejection head from the positive pressure to a negative pressure so that the liquid having been spread over the liquid ejection surface is collected into the nozzle, when the measured elapsed time reaches the set standby duration.

This aspect of the present invention is desirable especially in collecting adhering material of a smaller size than the diameter of the nozzle opening which adheres to the vicinity of the nozzle opening, such as liquid in the form of mist which is liable to be a cause of flight direction abnormalities.

According to the present invention, a pressure within a range that does not cause the liquid to be ejected from the nozzle is applied while maintaining a state where the liquid inside the nozzle is caused to protrude from the liquid ejection surface but to be still held at the nozzle. Therefore, even when there is variation in the amount of liquid which protrude form the liquid ejection surface, due to variations in the flow channel resistances of the nozzles and the pressure chambers, by combining the application of pressure by the pressure application device and the adjustment of internal pressure by the internal pressure adjustment device, it is possible to make the liquid bleed out reliably from the nozzle, and it is also possible to cause the ink which has bled out from the nozzle to spread uniformly on the liquid ejection surface to positions which are distant from the nozzle.

Moreover, by causing the liquid which has bled out from the nozzles to spread over the liquid ejection surface by maintaining the internal pressure of the liquid ejection head at a positive pressure, it is possible to make the solvent of the liquid come into contact with the adhering material (i.e., liquid in the form of a mist, or solidified liquid, or the like) which has adhered to the liquid ejection surface, and therefore the adhering material can be removed easily.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a general configuration diagram of an inkjet recording apparatus according to a first embodiment of the present invention;

FIG. 2 is a plan view of the principal part of the peripheral area of a print unit in the inkjet recording apparatus illustrated in FIG. 1;

FIGS. 3A to 3C are perspective plan views showing examples of the composition of a print head;

FIG. 4 is a cross-sectional view along line 4-4 in FIGS. 3A and 3B;

FIG. 5 is a conceptual diagram showing the composition of an ink supply system of the inkjet recording apparatus shown in FIG. 1;

FIG. 6 is a conceptual diagram showing the composition of a control system of the inkjet recording apparatus shown in FIG. 1;

FIGS. 7A to 7C are diagrams showing the behavior of ink in performing the ink ejection surface maintenance according to an embodiment of the present embodiment;

FIGS. 8A and 8B are diagrams showing examples of a non-ejection drive signal;

FIG. 9 is a flowchart of an ink ejection surface maintenance control procedure according to the first embodiment of the present invention;

FIG. 10 is a diagram showing cleaning modes in an ink ejection surface maintenance control procedure according to the first embodiment of the present invention;

FIG. 11 is a flowchart of a cleaning mode judgment routine in the flowchart shown in FIG. 9;

FIG. 12 is a conceptual diagram showing an ink ejection surface maintenance control procedure according to a second embodiment of the present invention;

FIG. 13 is a flowchart of an ink ejection surface maintenance control procedure according to the second embodiment of the present invention;

FIGS. 14A and 14B are diagrams showing head internal pressure control in an ink ejection surface maintenance control procedure according to the second embodiment of the present invention; and

FIG. 15 is a flowchart of an ink ejection surface maintenance control procedure according to a third embodiment of the present invention.

### DETAILED DESCRIPTION OF THE PREFERRED EMBODIMENTS

### General Configuration of Apparatus

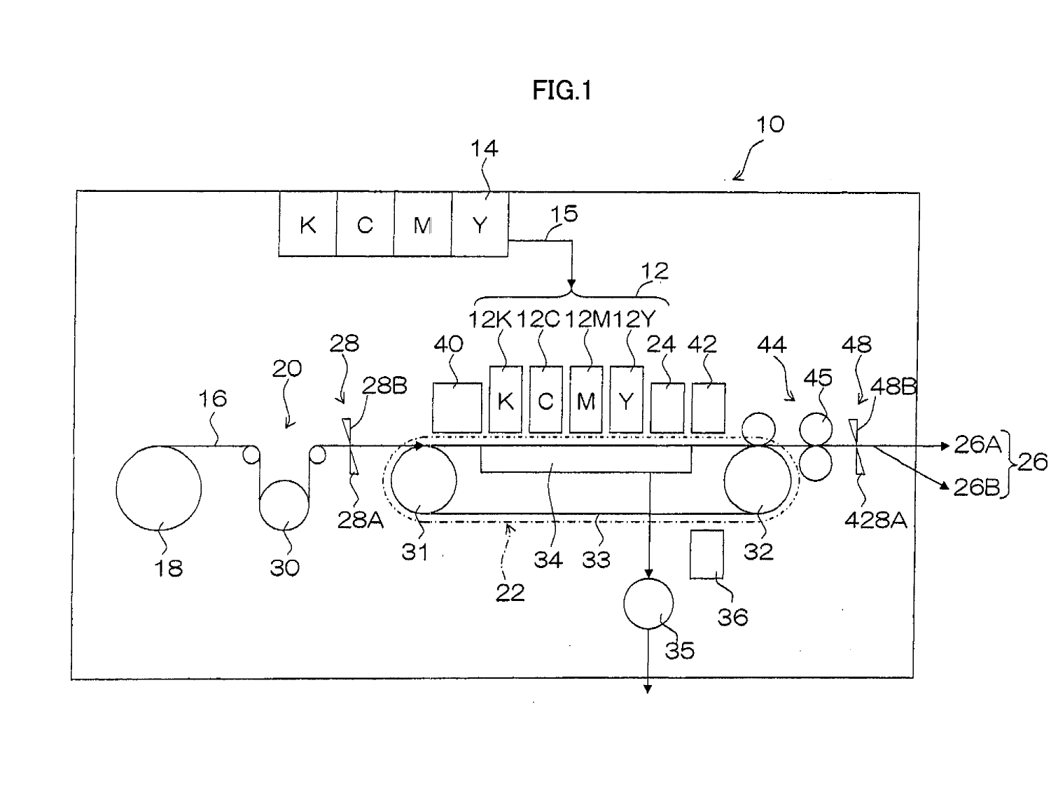

The present embodiment relates to an inkjet recording apparatus (image forming apparatus) which forms a desired color image by means of colored inks ejected onto a recording medium, as one example of a liquid ejection apparatus according to the present invention. FIG. 1 is a general configuration diagram of an inkjet recording apparatus according to an embodiment of the present invention. As shown in FIG. 1, the inkjet recording apparatus 10 comprises: a print unit 12 having a plurality of inkjet heads (hereafter, called “heads”) 12K, 12C, 12M, and 12Y provided for ink colors of black (K), cyan (C), magenta (M), and yellow (Y), respectively; an ink storing and loading unit 14 for storing inks of K, C, M and Y to be supplied to the print heads 12K, 12C, 12M, and 12Y; a paper supply unit 18 for supplying recording paper 16 which is a recording medium; a decurling unit 20 removing curl in the recording paper 16; a suction belt conveyance unit 22 disposed facing ink-droplet ejection surface (the nozzle forming face S1) of each head 12K, 12C, 12M, and 12Y; for conveying the recording paper 16 while keeping the recording paper 16 flat; and a paper output unit 26 for outputting image-printed recording paper (printed matter) to the exterior.

The ink storing and loading unit 14 has ink tanks for storing the inks of K, C, M and Y to be supplied to the heads 12K, 12C, 12M, and 12Y, and the inks of respective colors are connected to the heads 12K, 12C, 12M, and 12Y by means of ink flow channels 15.

The ink storing and loading unit 14 has a warning device (for example, a display device or an alarm sound generator) for warning when the remaining amount of any ink is low, and has a mechanism for preventing loading errors among the colors. The details of the ink supply system including the ink storing and loading unit 14 shown in FIG. 1 are described below.

In FIG. 1, a magazine for rolled paper (continuous paper) is shown as an example of the paper supply unit 18; however, more magazines with paper differences such as paper width and quality may be jointly provided. Moreover, papers may be supplied with cassettes that contain cut papers loaded in layers and that are used jointly or in lieu of the magazine for rolled paper.

In the case of a configuration in which a plurality of types of recording paper can be used, it is preferable that an information recording medium such as a bar code and a wireless tag containing information about the type of paper is attached to the magazine, and by reading the information contained in the information recording medium with a predetermined reading device, the type of recording medium to be used (type of medium) is automatically determined, and ink-droplet ejection is controlled so that the ink-droplets are ejected in an appropriate manner in accordance with the type of medium.

The recording paper 16 delivered from the paper supply unit 18 retains curl due to having been loaded in the magazine. In order to remove the curl, heat is applied to the recording paper 16 in the decurling unit 20 by a heating drum 30 in the direction opposite from the curl direction in the magazine. The heating temperature at this time is preferably controlled so that the recording paper 16 has a curl in which the surface on which the print is to be made is slightly round outward.

In the case of the configuration in which roll paper is used, a cutter (first cutter) 28 is provided as shown in FIG. 1, and the continuous paper is cut into a desired size by the cutter 28. The cutter 28 has a stationary blade 28A, whose length is not less than the width of the conveyor pathway of the recording paper 16, and a round blade 28B, which moves along the stationary blade 28A. The stationary blade 28A is disposed on the reverse side of the printed surface of the recording paper 16, and the round blade 28B is disposed on the printed surface side across the conveyor pathway. When cut papers are used, the cutter 28 is not required.

The decurled and cut recording paper 16 is delivered to the suction belt conveyance unit 22. The suction belt conveyance unit 22 has a configuration in which an endless belt 33 is set around rollers 31 and 32 so that the portion of the endless belt 33 facing at least the nozzle face (also referred to as “ink ejection surface” or “liquid ejection surface”) of the print unit 12 forms a horizontal plane (flat plane).

The belt 33 has a width that is greater than the width of the recording paper 16, and a plurality of suction apertures (not shown) are formed on the belt surface. A suction chamber 34 is disposed in a position facing the nozzle surface of the print unit 12 on the interior side of the belt 33, which is set around the rollers 31 and 32, as shown in FIG. 1. The suction chamber 34 provides suction with a fan 35 to generate a negative pressure, and the recording paper 16 is held on the belt 33 by suction.

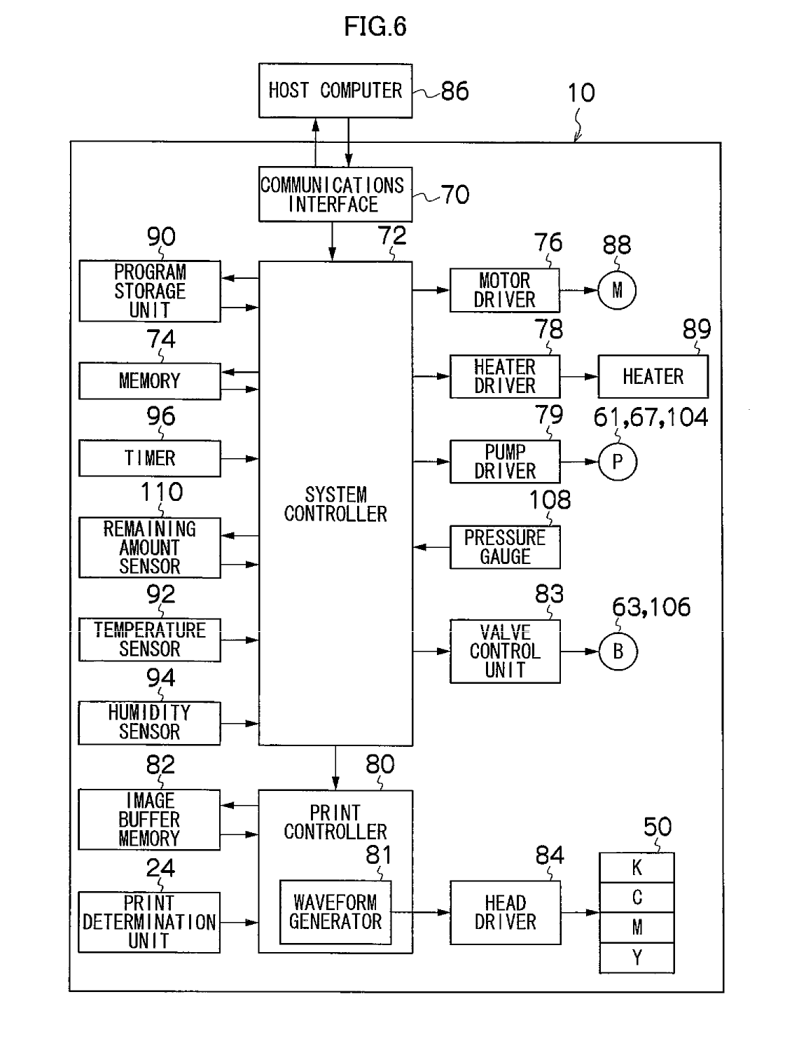

The belt 33 is driven in the clockwise direction in FIG. 1 by the motive force of a motor (not shown in FIG. 1, but shown by reference numeral 88 in FIG. 6) being transmitted to at least one of the rollers 31 and 32, which the belt 33 is set around, and the recording paper 16 held on the belt 33 is conveyed from left to right in FIG. 1.

Since ink adheres to the belt 33 when a marginless print job or the like is performed, a belt-cleaning unit 36 is disposed in a predetermined position (a suitable position outside the printing area) on the exterior side of the belt 33. Although the details of the configuration of the belt-cleaning unit 36 are not shown, examples thereof include a configuration in which the belt 33 is nipped with cleaning rollers such as a brush roller and a water absorbent roller, an air blow configuration in which clean air is blown onto the belt 33, or a combination of these. In the case of the configuration in which the belt 33 is nipped with the cleaning rollers, it is preferable to make the line velocity of the cleaning rollers different than that of the belt 33 to improve the cleaning effect.

The inkjet recording apparatus can comprise a roller nip conveyance mechanism, in place of the suction belt conveyance unit 22. However, there is a drawback in the roller nip conveyance mechanism that the print tends to be smeared when the printing area is conveyed by the roller nip action because the nip roller makes contact with the printed surface of the paper immediately after printing. Therefore, the suction belt conveyance in which nothing comes into contact with the image surface in the printing area is preferable.

A heating fan 40 is disposed on the upstream side of the print unit 12 in the conveyance pathway formed by the suction belt conveyance unit 22. The heating fan 40 blows heated air onto the recording paper 16 to heat the recording paper 16 immediately before printing so that the ink deposited on the recording paper 16 dries more easily.

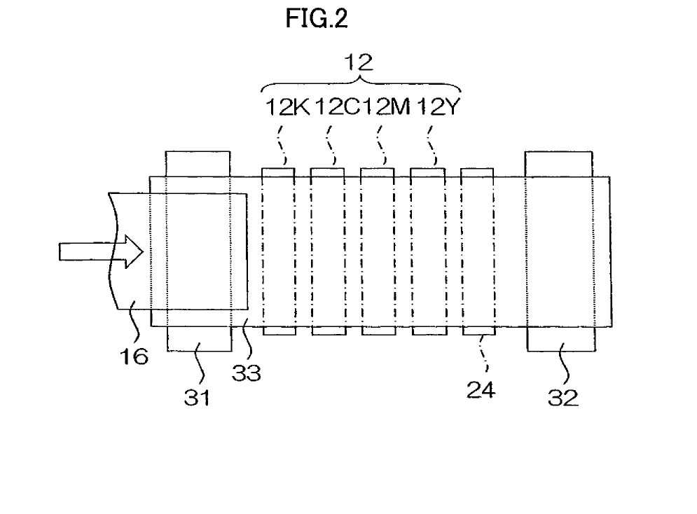

The heads 12K, 12C, 12M and 12Y of the print unit 12 are full line heads having a length corresponding to the maximum width of the recording paper 16 used with the inkjet recording apparatus 10, and comprising a plurality of nozzles for ejecting ink arranged on a nozzle face through a length exceeding at least one edge of the maximum-size recording medium (namely, the full width of the printable range) (see FIG. 2).

The print heads 12K, 12C, 12M and 12Y are arranged in color order (black (K), cyan (C), magenta (M), yellow (Y)) from the upstream side in the feed direction of the recording paper 16, and these respective heads 12K, 12C, 12M and 12Y are fixed extending the conveyance direction (hereafter, the paper conveyance direction) of the recording paper 16.

A color image can be formed on the recording paper 16 by ejecting inks of different colors from the heads 12K, 12C, 12M and 12Y, respectively, onto the recording paper 16 while the recording paper 16 is conveyed by the suction belt conveyance unit 22.

By adopting a configuration in which the full line heads 12K, 12C, 12M and 12Y having nozzle rows covering the full paper width are provided for the respective colors in this way, it is possible to record an image on the full surface of the recording paper 16 by performing just one operation of relatively moving the recording paper 16 and the print unit 12 in the paper conveyance direction (the sub-scanning direction), in other words, by means of a single sub-scanning action. Higher-speed printing is thereby made possible and productivity can be improved in comparison with a shuttle type head configuration in which a recording head reciprocates in the main scanning direction.

Although the configuration with the KCMY four standard colors is described in the present embodiment, combinations of the ink colors and the number of colors are not limited to those. Light inks, dark inks or special color inks can be added as required. For example, a configuration is possible in which inkjet heads for ejecting light-colored inks such as light cyan and light magenta are added. Furthermore, there are no particular restrictions of the sequence in which the heads of respective colors are arranged. In an inkjet recording apparatus based on a two-liquid system in which treatment liquid and ink are deposited on the recording paper 16, and the ink coloring material is caused to aggregate or become insoluble on the recording paper 16, thereby separating the ink solvent and the ink coloring material on the recording paper 16, it is possible to provide an inkjet head as a device for depositing the treatment liquid onto the recording paper 16.

A post-drying unit 42 is disposed following the print unit 12. The post-drying unit 42 is a device to dry the printed image surface, and includes a heating fan, for example. It is preferable to avoid contact with the printed surface until the printed ink dries, and a device that blows heated air onto the printed surface is preferable.

A heating/pressurizing unit 44 is disposed following the post-drying unit 42. The heating/pressurizing unit 44 is a device to control the glossiness of the image surface, and the image surface is pressed with a pressure roller 45 having a predetermined uneven surface shape while the image surface is heated, and the uneven shape is transferred to the image surface.

When the recording paper 16 is pressed by means of the heating/pressurizing unit 44, in cases in which printing is performed with dye-based ink on porous paper, blocking the pores of the paper by the application of pressure prevents the ink from coming contact with ozone and other substance that cause dye molecules to break down, and has the effect of increasing the durability of the print.

The printed matter generated in this manner is outputted from the paper output unit 26. The target print (i.e., the result of printing the target image) and the test print are preferably outputted separately. In the inkjet recording apparatus 10, a sorting device (not shown) is provided for switching the outputting pathways in order to sort the printed matter with the target print and the printed matter with the test print, and to send them to paper output units 26A and 26B, respectively. When the target print and the test print are simultaneously formed in parallel on the same large sheet of paper, the test print portion is cut and separated by a cutter (second cutter) 48. The cutter 48 is disposed directly in front of the paper output unit 26, and is used for cutting the test print portion from the target print portion when a test print has been performed in the blank portion of the target print. The structure of the cutter 48 is the same as the first cutter 28 described above, and has a stationary blade 48A and a round blade 48B.

Although not shown in FIG. 1, the paper output unit 26A for the target prints is provided with a sorter for collecting prints according to print orders.

### Structure of the Head

Next, the stricture of a head will be described. The heads 12K, 12C, 12M and 12Y of the respective ink colors have the same structure, and a reference numeral 50 is hereinafter designated to any of the heads.

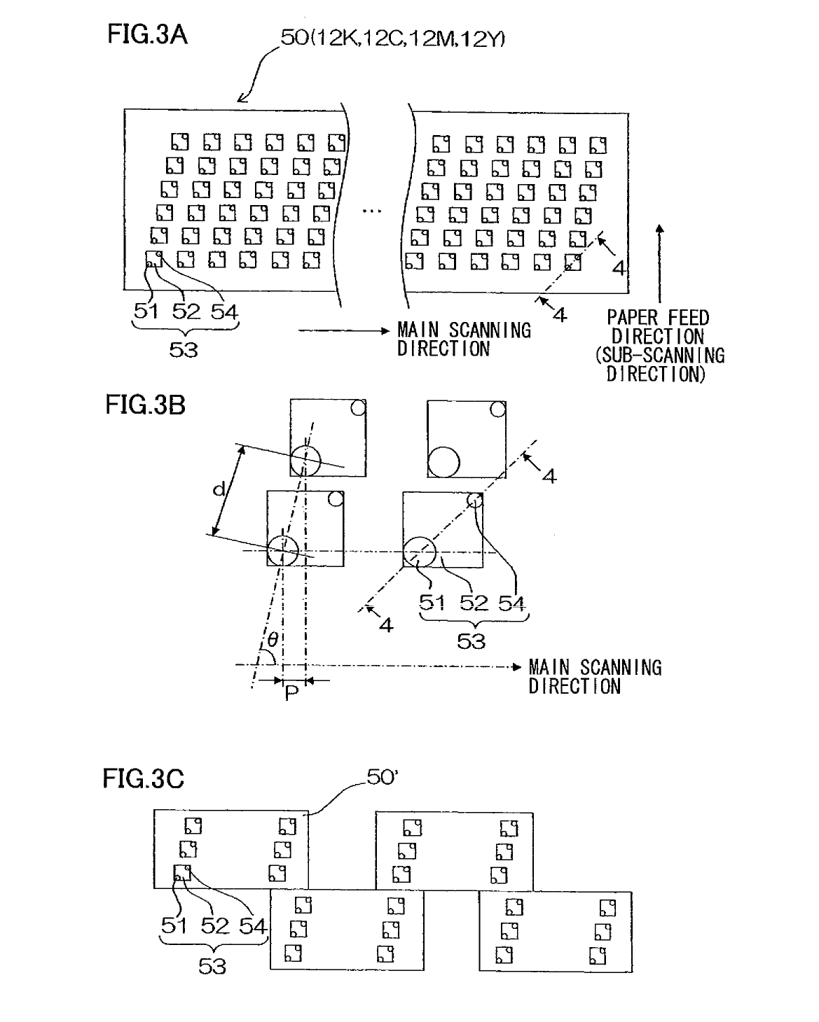

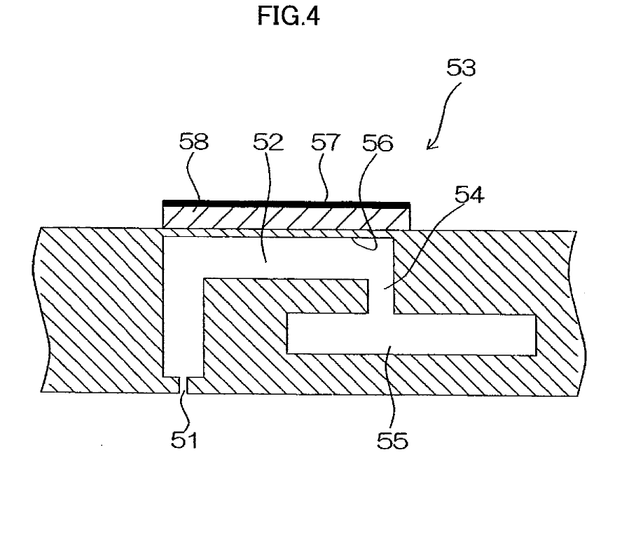

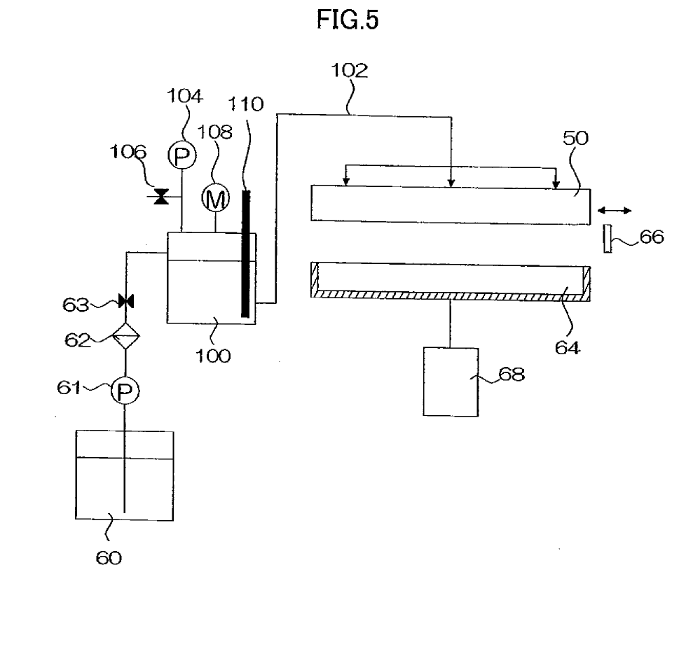

FIG. 3A is a perspective plan view showing an example of the configuration of the head 50, FIG. 3B is an enlarged view of a portion thereof, FIG. 3C is a perspective plan view showing another example of the configuration of the head 50, and FIG. 4 is a cross-sectional view taken along the line 4-4 in FIGS. 3A and 3B, showing the stereoscopic structure.

The nozzle pitch in the head 50 is required to be minimized in order to maximize the density of the dots printed on the surface of the recording paper 16. As shown in FIGS. 3A and 3B, the head 50 according to the present embodiment has a structure in which a plurality of ink chamber units 53, each comprising a nozzle 51 forming an ink droplet ejection restrictors, a pressure chamber 52 corresponding to the nozzle 51, and the like, are disposed two-dimensionally in the form of a staggered matrix, and hence the effective nozzle interval (the projected nozzle pitch) as projected in the lengthwise direction of the head (the direction perpendicular to the paper conveyance direction) is reduced and high nozzle density is achieved.

The mode of forming one or more nozzle rows through a length corresponding to the entire width of the recording paper 16 in a direction substantially perpendicular to the conveyance direction of the recording paper 16 is not limited to the example described above. For example, instead of the configuration in FIG. 3A, as shown in FIG. 3C, a line head having nozzle rows of a length corresponding to the entire width of the recording paper 16 can be formed by arranging and combining, in a staggered matrix, short head blocks 50′ having a plurality of nozzles 51 arrayed in a two-dimensional fashion. Moreover, it is also possible to compose a line head by aligning short heads together in one row (see FIG. 12).

The planar shape of the pressure chamber 52 provided for each nozzle 51 is substantially a square, and the nozzle 51 and the supply port 54 are disposed in both corners on a diagonal line of the square. Each pressure chamber 52 is connected to a common channel 55 through the supply port 54. The common channel 55 is connected to an ink tank 60 (not shown in FIG. 4, but shown in FIG. 5), which is a base tank that supplies ink, and the ink supplied from the ink tank is delivered through the common flow channel 55 in FIG. 4 to the pressure chambers 52.

A piezoelectric element 58 provided with an individual electrode 57 is bonded to a diaphragm 56 which forms the upper face of the pressure chamber 52 and also serves as a common electrode, and the piezoelectric element 58 is deformed when a drive voltage is supplied to the individual electrode 57, thereby causing ink to be ejected from the nozzle 51. When ink is ejected, new ink is supplied to the pressure chamber 52 from the common flow channel 55 through the supply port 54.

As shown in FIG. 3B, the high-density nozzle head according to the present embodiment is achieved by arranging a plurality of ink chamber units 53 having the above-described structure in a lattice fashion based on a fixed arrangement pattern, in a row direction which coincides with the main scanning direction, and a column direction which is inclined at a fixed angle of θ with respect to the main scanning direction, rather than being perpendicular to the main scanning direction.

More specifically, by adopting a structure in which a plurality of ink chamber units 53 are arranged at a uniform pitch d in line with a direction forming an angle of θ with respect to the main scanning direction, the pitch P of the nozzles projected so as to align in the main scanning direction is d×cos θ, and hence the nozzles 51 can be regarded to be equivalent to those arranged linearly at a fixed pitch P along the main scanning direction. Such configuration results in a nuzzle structure in which the nozzle row projected in the main scanning direction has a high nozzle density of up to 2,400 nozzles per inch.

When implementing the present invention, the arrangement structure of the nozzles is not limited to the example shown in the drawings, and it is also possible to apply various other types of nozzle arrangements, such as an arrangement structure having one nozzle row in the sub-scanning direction.

Furthermore, the scope of the present invention is not limited to a printing system based on a line type of head, and it is also possible to adopt a serial system where a short head which is shorter than the breadthways dimension of the recording paper 16 is scanned in the breadthways direction of the recording paper 16, thereby performing printing in the breadthways direction, and when one printing action in the breadthways direction has been completed, the recording paper 16 is moved through a prescribed amount in the direction perpendicular to the breadthways direction, printing in the breadthways direction of the recording paper 16 is carried out in the next printing region, and by repeating this sequence, printing is performed over the whole surface of the printing region of the recording paper 16.

### Configuration of an Ink Supply System

FIG. 5 is a schematic drawing showing the configuration of the ink supply system in the inkjet recording apparatus 10. The ink tank 60 is a base tank that supplies ink to the head 50 and is included in the ink storing and loading unit 14 described above with reference to FIG. 1. The aspects of the ink tank 60 include a refillable type and a cartridge type: when the remaining amount of ink is low, the ink tank 60 of the refillable type is filled with ink through a filling port (not shown) and the ink tank 60 of the cartridge type is replaced with a new one. In order to change the ink type in accordance with the intended application, the cartridge type is suitable, and it is preferable to represent the ink type information with a bar code or the like on the cartridge, and to perform ejection control in accordance with the determined ink type.

As shown in FIG. 5, the ink tank 60 is connected to a sub tank 100 via a supply pump 61, a filter unit 62 and a supply valve 63, and the sub tank 100 is connected to the head 50 via an ink supply channel 102 (which corresponds to reference numeral 15 in FIG. 1).

When the supply valve 63 shown in FIG. 5 is opened and the supply pump 61 is operated, then ink from which foreign matter and gas bubbles have been removed by the filter unit 62 is supplied to the sub tank 100.

The filter mesh size in the filter unit 62 shown in FIG. 5 is preferably equivalent to or less than the diameter of the nozzle and commonly about 20 μm. The supply valve 63 and an atmosphere connection valve 106 shown in FIG. 5 are control valves controlled to open and to close by control signals from a control system (to be describe later).

A back pressure adjustment pump 104 which adjusts the back pressure (also referred to as the “internal pressure”) of the head 50 by adjusting the internal pressure of a sub tank 100, an atmosphere connection valve 106 which switches selectively between connecting the sub tank 100 to the outside atmosphere and shutting off (sealing) the sub tank 100 from the atmosphere, a pressure gauge 108 which measures the internal pressure of the sub tank 100, and a remaining amount determination sensor 110 which determines the remaining amount of ink in the sub tank 100, are connected to the sub tank 100. FIG. 5 shows a remaining amount determination sensor 110 based on a system which directly determines the level of the ink inside the sub tank 100, but it is also possible to adopt a system which determines the weight or resistance value of the ink inside the sub tank 100, and determines the remaining amount of ink inside the sub tank 100 from this determination value.

The sub tank 100 shown in FIG. 5 functions as a back pressure adjustment device which adjusts the internal pressure of the head 50. In other words, by changing the internal pressure of the sub tank 100 by operating the back pressure adjustment pump 104 in a state where the atmosphere connection valve 106 is closed, it is possible to change the internal pressure of the head 50. Furthermore, if the sub tank 100 is opened to the atmosphere by opening the atmosphere connection valve 106, then it is possible to change the internal pressure of the head 50 to the atmospheric pressure. The on and off switching of the back pressure adjustment pump 104 and the opening and closing of the atmosphere connection valve 106 shown in FIG. 5 are controlled on the basis of control signals sent from the control system, which is described hereinafter.

The inkjet recording apparatus 10 is also provided with a cap 64 as a device to prevent the nozzles 51 from drying out or to prevent an increase in the ink viscosity in the vicinity of the nozzles 51, and a blade 66 as a maintenance device (a device to clean) the ink ejection surface. A maintenance unit including the cap 64 and the blade 66 can be relatively moved with respect to the head 50 by a movement mechanism (not shown), and is moved from a predetermined holding position to a maintenance position under the head 50 as required.

The cap 64 is displaced up and down relatively with respect to the head 50 by an elevator mechanism (not shown). When the power of the inkjet recording apparatus 10 is turned OFF or when in a print standby state, the cap 64 is raised to a predetermined elevated position so as to come into close contact with the head 50, and the ink ejection surface is thereby covered with the cap 64.

The blade 66 is composed of an elastic member such as rubber or porous member such as foamed rubber, and can slide over the ink ejection surface (surface of the nozzle plate) of the head 50 by means of a blade movement mechanism (not shown). When an ink droplet or foreign matter has adhered to the ink ejection surface, the ink ejection surface (the surface of the nozzle plate) is wiped and cleaned by sliding the blade 66 over the ink ejection surface.

In the ink ejection surface maintenance control procedure adopted in the present embodiment, the back pressure in the head 50 is adjusted and the ink is made to project from the nozzles 51 (i.e., to protrude from the ink ejection surface), and while maintaining this state, the ink is made to flow out from the nozzles by applying energy of a level which does not cause droplets to be ejected from the nozzles, and furthermore, when the ink which has bled out from the nozzles has spread out over the ink ejection surface, a wiping operation of the ink ejection surface is performed by the blade 66.

For the blade 66 used in the present embodiment, it is desirable to use a blade composed of HNBR, which is hydrogenated NBR. Furthermore, it is also possible to use a blade 66 made of silicon rubber, urethane rubber, EPMD, or the like, a rolled nonwoven cloth, polyvinyl alcohol (PVA), or the like.

During printing or standby, when the frequency of use of specific nozzles is reduced and ink viscosity increases in the vicinity of those nozzles, a preliminary discharge is made to expel the degraded ink toward the cap 64.

Also, when bubbles have become intermixed in the ink inside the head 50 (for example, the ink inside the pressure chamber 52) or dissolved gas in the head 50 is converted into air bubbles as a result of an increase in temperature of the head, the cap 64 is placed on the head 50, the ink inside the pressure chamber 52 (the ink in which bubbles have become intermixed) is removed by suction with a suction pump 67, and the suction-removed ink is sent to a collection tank 68. This suction action is also performed so as to suction degraded ink whose viscosity has increased (hardened) or the degraded ink mixed with bubbles, when the ink is initially loaded into the head 50 or when service has started after a long period of being stopped.

When a state in which ink is not ejected from the head 50 continues for a certain amount of time or longer, the ink solvent in the vicinity of the nozzles 51 evaporates and ink viscosity increases. In such a state, ink can no longer be ejected from the nozzle 51 even when the piezoelectric element 58 for the ejection driving is operated. Before reaching such a state (in a viscosity range that allows ejection by the operation of the piezoelectric element 58) the piezoelectric element 58 is operated to perform the preliminary discharge to eject toward the ink receptor the ink whose viscosity has increased in the vicinity of the nozzle. After the ink ejection surface is cleaned with a wiper such as the blade 66 provided as the cleaning device for the ink ejection surface, a preliminary discharge is also carried out in order to remove the foreign matter inside the nozzles 51 by the wiper sliding operation. The preliminary discharge is also referred to as “dummy discharge”, “purge”, “liquid discharge”, and so on.

When bubbles have become intermixed in the nozzle 51 or the pressure chamber 52, or when the ink viscosity inside the nozzle 51 has exceeded a certain level, ink can no longer be ejected by the preliminary discharge, and a suctioning action is carried out as follows.

More specifically, when bubbles have become intermixed in the ink inside the nozzle 51 and the pressure chamber 52, ink can no longer be ejected from the nozzle 51 even when the piezoelectric element 58 is operated. Also, when the ink viscosity inside the nozzle 51 has exceeded a certain level, ink can no longer be ejected from the nozzle 51 even when the actuator 58 is operated. In these cases, a suctioning device to remove the ink inside the pressure chamber 52 by suction with a suction pump, or the like, is placed on the nozzle face of the head 50, and the ink in which bubbles have become intermixed or the ink whose viscosity has increased is removed by suction.

However, since this suction action is performed with respect to all the ink in the pressure chambers 52, the amount of ink consumption is considerable. Therefore, a preferred aspect is one in which a preliminary discharge is performed when the increase in the viscosity of the ink is small.

### Description of Control System

FIG. 6 is a principal block diagram showing the system configuration of the inkjet recording apparatus 10. The inkjet recording apparatus 10 comprises a communication interface 70, a system controller 72, an image memory 74, a motor driver 76, a heater driver 78, a pump driver 79, valve control section 83, a print controller 80, an image buffer memory 82, a head driver 84, and the like.

The communication interface 70 is an interface unit for receiving image data sent from a host computer 86. A serial interface such as USB (Universal Serial Bus), IEEE1394, Ethernet (registered trademark), wireless network, or a parallel interface such as a Centronics interface may be used as the communication interface 70. A buffer memory (not shown) may be mounted in this portion in order to increase the communication speed. The image data sent from the host computer 86 is received by the inkjet recording apparatus 10 through the communication interface 70, and is temporarily stored in the image memory 74.

The image memory 74 is a storage device for temporarily storing images inputted through the communication interface 70, and data is written and read to and from the image memory 74 through the system controller 72. The image memory 74 is not limited to a memory composed of semiconductor elements, and a hard disk drive or another magnetic medium may be used.

The system controller 72 is constituted by a central processing unit (CPU) and peripheral circuits thereof, and the like, and it functions as a control device for controlling the whole of the inkjet recording apparatus 10 in accordance with a prescribed program, as well as a calculation device for performing various calculations. More specifically, the system controller 72 controls the various sections, such as the communication interface 70, image memory 74, motor driver 76, heater driver 78, and the like, as well as controlling communications with the host computer 86 and writing and reading to and from the image memory 74, and it also generates control signals for controlling the motor 88 and heater 89 of the conveyance system, a pump (a supply pump 61, a suction pump 67, the back pressure adjustment pump 104, and or like, in FIG. 5).

The program executed by the CPU of the system controller 72 and the various types of data which are required for control procedures are stored in a image memory 74. The a image memory 74 may be a non-writeable storage device, or it may be a rewriteable storage device, such as an EEPROM. The image memory 74 is used as a temporary storage region for the image data, and it is also used as a program development region and a calculation work region for the CPU.

The motor driver 76 is a driver (driving circuit) that drives the motor 88 in accordance with commands from the system controller 72. In FIG. 6, the motors (actuators) disposed in the respective sections of the apparatus are represented by the reference numeral 88. For example, the motor 88 shown in FIG. 6 includes a motor which drives the roller 31 (32) in FIG. 1, a motor of the movement mechanism which moves the cap 64 in FIG. 5, a motor of the movement mechanism which moves the blade 66 in FIG. 5, and the like.

The heater driver 78 is a driver which drives heaters 89, including a heater forming a heat source of the heating fan 40 shown in FIG. 1, a heater of the post drying unit 42, a heater which adjusts the temperature of the head 50, and the like, in accordance with instructions from the system controller 72.

The pump driver 79 controls the driving of the supply pump 61, the suction pump 67, and the back pressure adjustment pump 104 shown in FIG. 5, on the basis of the control signals from the system controller 72. Furthermore, the system controller 72 controls the opening and closing of the valves, such as the supply valve 63 and the atmosphere connection valve 106, and the like, shown in FIG. 5, via the valve control section 83.

When a determination signal is sent to the system controller 72 in FIG. 6 from the remaining amount determination sensor 110 provided inside the sub tank 100 shown in FIG. 5, the system controller 72 judges whether or not the remaining amount of ink inside the sub tank 100 in FIG. 5 is smaller than a prescribed amount, on the basis of this remaining amount determination signal. If it is judged that the remaining amount of ink inside the sub tank 100 is smaller than the prescribed amount, then the system controller 72 implements control whereby the supply valve 63 in FIG. 6 is opened via the valve control section 83, and furthermore, the system controller 72 operates the supply pump 61 via the pump driver 79, thereby replenishing ink from the ink tank 60 into the sub tank 100.

Furthermore, if a signal corresponding to the pressure measurement value is sent to the system controller 72 from the pressure gauge 108 provided in the sub tank 100 in FIG. 5, then the system controller 72 controls the operation of the back pressure adjustment pump 104 via the pump driver 79 on the basis of the measurement value of the pressure gauge 108, in such a manner that the internal pressure of the sub tank 100 assumes a prescribed value. If the internal pressure of the head 50 is set to the atmospheric pressure, then the system controller 72 implements control in such a manner that the back pressure adjustment pump 104 is halted, and furthermore the atmospheric connection valve 106 is opened by the valve control section 83.

The print controller 80 has a signal processing function for performing various tasks, compensations, and other types of processing for generating print control signals from the image data stored in image memory 74 in accordance with commands from the system controller 72 so as to supply the generated print data (dot data) to the head driver 84. Prescribed signal processing is carried out in the print controller 80, and the ejection amount and the ejection timing of the ink droplets from the respective print heads 50 are controlled via the head driver 84, on the basis of the print data. By this means, prescribed dot size and dot positions can be achieved.

The print controller 80 is provided with the image buffer memory 82; and image data, parameters, and other data are temporarily stored in the image buffer memory 82 when image data is processed in the print controller 80. Also possible is an aspect in which the print controller 80 and the system controller 72 are integrated to form a single processor.

The head driver 84 drives the piezoelectric element 58 of the heads 50 on the basis of print data supplied by the print controller 80. The head driver 84 can be provided with a feedback control system for maintaining constant drive conditions for the print heads.

The print determination unit 24 is a block that includes the line sensor as described above with reference to FIG. 1, reads the image printed on the recording paper 16, determines the print conditions (presence of the ejection, variation in the dot formation, and the like) by performing required signal processing, or the like, and provides the determination results of the print conditions to the print controller 80.

According to requirements, the print controller 80 makes various corrections and maintenance with respect to the head 50 on the basis of information obtained from the print determination unit 24.

The image data to be printed is externally inputted through the communication interface 70, and is stored in the image memory 74. In this stage, the RGB image data is stored in the image memory 74.

The image data stored in the image memory 74 is sent to the print controller 80 through the system controller 72, and is converted to the dot data for each ink color in the print controller 80. In other words, the print controller 80 performs processing for converting the inputted RGB image data into dot data for four colors, K, C, M and Y. The dot data generated by the print controller 80 is stored in the image buffer memory 82.

In the waveform generating section 81 shown in FIG. 6, a drive signal waveform is generated on the basis of the dot data stored in the image buffer memory 82. This drive waveform signal is supplied to the head driver 84 which generates a drive signal for the head 50, and by applying the drive signal generated by the head driver 84, to the head 50, ink is ejected from the head 50. By controlling ink ejection from the heads 50 in synchronization with the conveyance velocity of the recording paper 16, an image is formed on the recording paper 16.

In the present embodiment, the waveform generating section 81 also generates a waveform of a non-ejection drive signal, which is used for the ink ejection surface maintenance control described below and which is used to apply pressure to the ink inside the nozzles within a range that does not cause the ink to be ejected from the nozzles. In other words, in the control procedure for maintenance of the ink ejection surface, a control signal is supplied from the system controller 72 to the print controller 80, and when the print controller 80 acquires this control signal, it transmits a control signal for generating a waveform of a non-ejection drive signal to the waveform generating section 81, and the head driver 84 is controlled in such a manner that a non-ejection drive signal is applied to the piezoelectric elements 58 in FIG. 4. The details of the non-ejection drive signal are described hereinafter.

Various control programs are stored in a program storage section 90, and a control program is read out and executed in accordance with commands from the system controller 72. The program storage section 90 may use a semiconductor memory, such as a ROM, EEPROM, or a magnetic disk, or the like. An external interface may be provided, and a memory card or PC card may also be used. Naturally, a plurality of these storage media may also be provided. The program storage section 90 may also be combined with a storage device for storing operational parameters, and the like (not shown).

The inkjet recording apparatus 10 shown in the present example comprises a temperature sensor 92 which determines the temperatures of the respective sections inside the inkjet recording apparatus 10, and a humidity sensor 94 which determines the humidities of the respective sections inside the apparatus. In FIG. 6, a plurality of temperature sensors provided in the respective sections of the apparatus are represented by the reference numeral 92, and a plurality of humidity sensors provided in the respective sections of the apparatus are represented by the reference numeral 94.

The determination signals from the temperature sensors 92 and the humidity sensors 94 provided in the respective sections of the apparatus are sent to the system controller 72. The system controller 72 operates the temperature adjustment device and the humidity adjustment device of the respective sections of the apparatus, on the basis of the temperature determination signal sent from the temperature sensor 92 and the humidity determination signal sent from the humidity sensor 94. For example, a head temperature determination sensor which determines the temperature of the interior and the periphery of the head 50 and a head humidity determination sensor which determines the humidity of the periphery of the head 50 are provided, and the ink droplet volume ejected from the head 50 is corrected on the basis of the internal temperature of the head 50 (the temperature of the ink inside the head 50), the temperature of the periphery of the head 50, and the humidity of the periphery of the head 50.

Furthermore, a timer 96 which is appended to the system controller 72 functions as a measurement device for measuring the time between the control stages. It is also possible to adopt a mode in which a timer 96 is provided inside the processor which constitutes the system controller 72, or the like.

### Description of Ink Ejection Surface Maintenance Control (Method)

Next, the ink ejection surface maintenance control (method) according to an embodiment of the present invention will be described in detail. As described previously, in the ink ejection surface maintenance control according to the present embodiment, ink is caused to bleed out onto the ink ejection surface from the nozzles, and furthermore, the ink ejection surface is wiped with a blade, in a state where the ink has bled out onto the ink ejection surface from the nozzles and has spread over the ink ejection surface.

By causing the ink to spread over the ink ejection surface, it is possible to make the ink come into contact with the adhering material which is attached to regions that are distant from the nozzles. This facilitates removal of the adhering material from the ink ejection surface in wiping the ink ejection surface by means of the blade. Examples of the adhering material attached to the ink ejection surface include: ink which is scattered on the ink ejection surface during ink ejection; ink which has adhered to the ink ejection surface and has cured; paper dust generated by the recording paper 16, and the like.

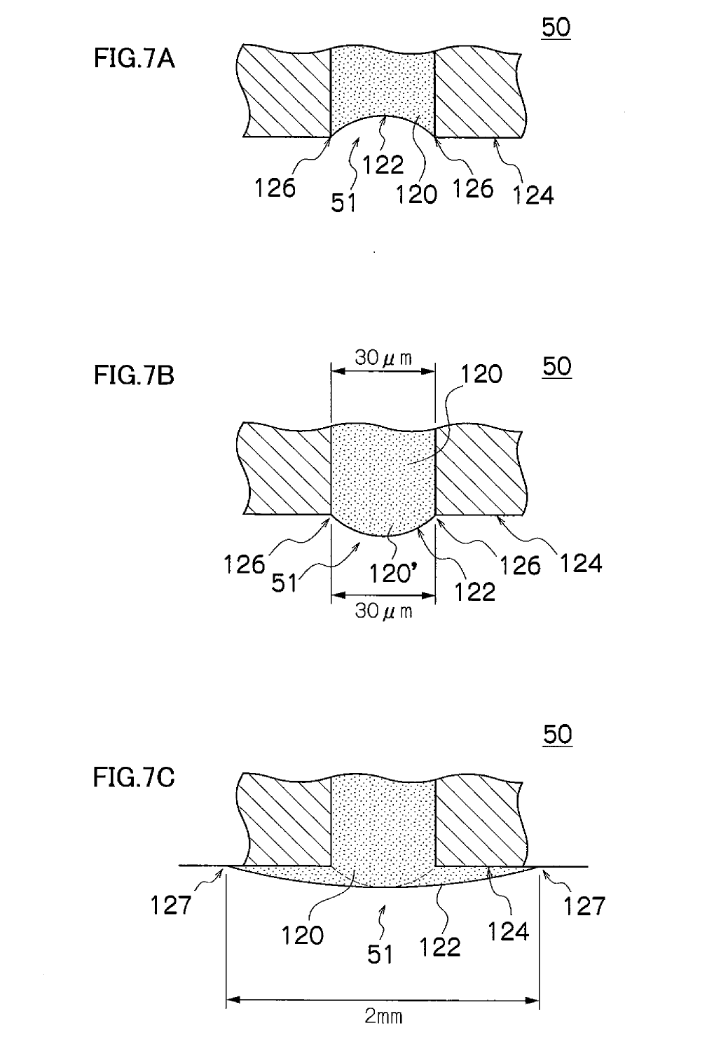

The control procedure for causing ink to bleed out from the nozzles onto the ink ejection surface and causing the ink to spread over the ink ejection surface is described with reference to FIGS. 7A to 7C.

FIG. 7A shows a state of the ink 120 inside a nozzle 51 in an ejection standby state. In the ejection standby state shown in FIG. 7A, a meniscus 122 is formed inside the nozzle 51. The term “meniscus 122” indicates a gas-liquid interface between the atmosphere and the ink 120 inside the nozzle. In the ejection standby state shown in FIG. 7A, negative pressure is applied to the ink 120 inside the head 50 in such a manner that the shape of the meniscus 122 is a concave shape which is recessed toward the inside of the nozzle 51. In this state, the meniscus 122 is clipped (held) at the edge of the nozzle 51 (at the clip point 126 which is the boundary between the liquid-philic portion on the interior of the nozzle 51 and the liquid-phobic portion on the ink ejection surface 124).

FIG. 7B shows a state where a positive pressure is applied to the head 50 in a maintenance mode (the operational mode of the inkjet recording apparatus 10 during implementation of the ink ejection surface maintenance control described in the present embodiment), in such a manner that the ink 120 inside the nozzle 51 protrude from the ink ejection surface 124. In the state of positive pressure application shown in FIG. 7B, the internal pressure of the sub tank 100 (see FIG. 5) applied to the ink 120 inside the head 50 is greater than during the ejection standby state (internal pressure of head during ejection standby<internal pressure of head in positive pressure application state), but the positive pressure is applied in a range which does not cause the ink inside the nozzle 51 to leak out from the nozzle 51. When the positive pressure described above is applied to the interior of the head 50, the meniscus 122 projects to the outside of the nozzle 51, and the shape of the meniscus 122 is a projecting shape which protrudes toward the outside of the nozzle 51. However, since the meniscus 122 is maintained in a clipped state at the edge 126 of the nozzle 51, then the ink 120 inside the nozzle 51 does not leak out to the exterior of the nozzle 51.

The ink 120 which projects to the outside of the nozzle 51 as shown in FIG. 7B has substantially the same width (diameter) as the diameter of the nozzle 51. For example, if the nozzle 51 has a diameter of 30 μm, then the width (diameter) of the ink 120′ projecting to the outside of the nozzle 51 is also 30 μm. The planar shape of the ink 120′ projecting from the nozzle 51 (the shape of the ink as viewed from the outside of the nozzle 51) is considered to be a substantially circular shape, which is similar to the shape of the opening of the nozzle 51.

If the piezoelectric element 58 is operated by applying a non-ejection drive signal for a short time period (i.e., pressure application duration) to the piezoelectric element 58 while maintaining a state of positive pressure application as shown in FIG. 7B, then a shock is applied to the clip point 126 of the meniscus 122 due to the action of the piezoelectric element 58, and therefore the boundary 127 of the meniscus 122 moves onto the ink ejection surface 124 to the outside of the nozzle 51, and the ink is thus caused to flow out from the nozzle 51 onto the ink ejection surface 124, as shown in FIG. 7C. When the positive pressure applied to the head 50 is maintained in a state where the boundary 127 of the meniscus 122 has moved onto the ink ejection surface 124, then the ink which has bled out from the nozzle 51 continues to spread over the ink ejection surface 124 as long as the application of the positive pressure continues.

A desirable mode is one where the pressure application duration during which the non-ejection drive signal is applied to the piezoelectric element 58, is changed in accordance with the state of the ink inside the nozzle 51. For example, in a state where no increase in the viscosity of the ink has occurred and where normal ink ejection is possible from all of the nozzles of the head 50, the application time is set to 0.1 seconds, whereas in a case where increase in the viscosity of the ink inside the nozzle 51 is considered to have occurred, due to the environment or use conditions of the head 50, then the pressure application duration is set to a maximum time of 1 second, for example. By changing the pressure application duration of the non-ejection drive signal in accordance with the viscosity of the ink inside the nozzles in this way, (namely, by increasing the pressure application duration of the non-ejection drive signal if the ink viscosity increases), it is possible to eliminate the effects of the increase in the viscosity of the ink inside the nozzles 51 arising as a result of the environment or use conditions of the head 50.

In the positive pressure application state shown in FIG. 7B, the amount of protuberance (amount of projection) of the ink which projects from the ink ejection surface 124 may vary due to variations in the flow channel resistances of the nozzles 51 or variations in the viscosities of the ink inside the nozzles 51. However, when the piezoelectric element 58 is operated by applying a non-ejection drive signal to the piezoelectric element 58, whether the ink is flowed out from the nozzles 51 largely depends on the pressure applied to the ink by the piezoelectric element 58, and therefore it is possible to make the ink flow out from all of the nozzles 51. Consequently, there is no occurrence of nozzles where the ink does not bleed out (nozzles where the ink is retained inside the nozzle), irrespective of the variations in the flow channel resistances of the respective nozzles 51 or variations in the viscosity of the ink inside the nozzles 51, or the like.

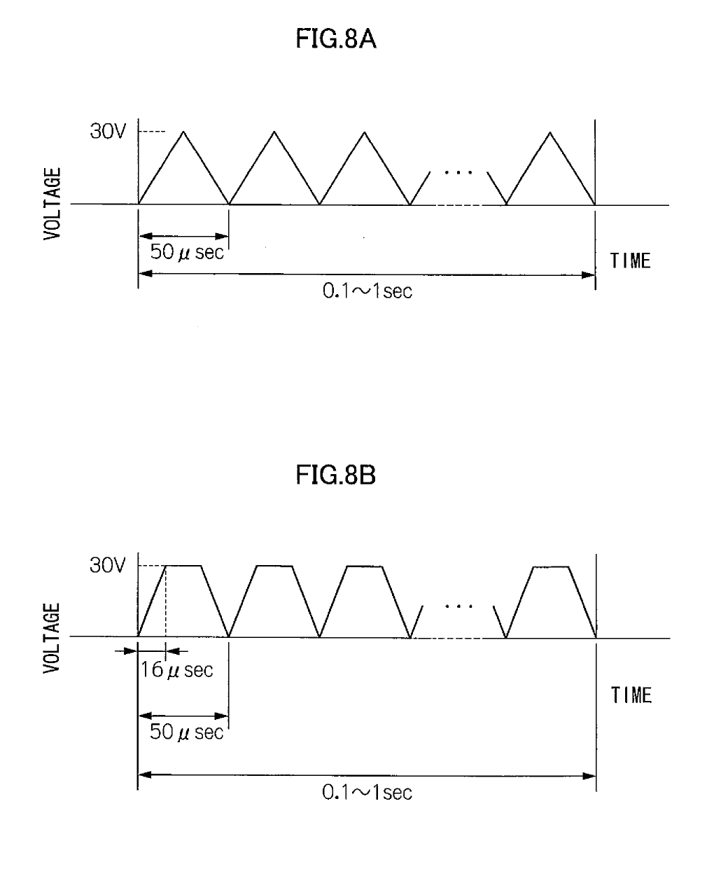

FIGS. 8A and 8B show examples of the waveform of the non-ejection drive signal which is applied to the piezoelectric element 58. The waveform of the non-ejection drive signal may adopt a triangular wave having a prescribed cycle (50 μsec) as shown in FIG. 8A, or a trapezoid wave as shown in FIG. 8B.

The non-ejection drive signal according to the present embodiment is a drive signal which does not cause ink to be ejected from the nozzle 51 even when applied to the piezoelectric element 58, but which can cause the meniscus 122 to move toward the ink ejection surface 124 when applied to the piezoelectric element 58 in a state of positive pressure application as shown in FIG. 7B.

In the present embodiment, as shown in FIGS. 8A and 8B, the waveform used for the non-ejection drive signal has a maximum amplitude (maximum voltage) of 30V, and a cycle of 50 μsec (frequency 20 kHz).

FIG. 8A shows an example of a non-ejection drive signal composed of a set of signal components each of which is triangular non-ejection drive signal component having an equal rise time and fall time (16 μsec). FIG. 8B shows an example of a non-ejection drive signal composed of a set of signal components each of which is trapezoid-shaped non-ejection drive signal component having an equal rise time and fall time and having a time period during which the maximum voltage is maintained. However, the waveform of the non-ejection drive elements is not limited to shapes of this kind which are symmetrical in the time axis direction and it is also possible to adopt a triangular waveform or a trapezoid-shaped waveform in which the rise time or the fall time is different.

Moreover, it is possible to adopt a mode in which the standard pressure application duration of the non-ejection drive signal is 0.1 sec (corresponding to 2000 repeats of a waveform having a period cycle of 50 μsec), and when the increase in the viscosity of the ink inside the nozzles 51 due to the environment or the use conditions of the head 50 is taken into account, the maximum pressure application duration may be approximately 1 sec (corresponding to 20000 repeats of a waveform having a period cycle of 50 μsec).

When the ink flows out from the nozzle 51, then the meniscus 122 is no longer able to be clipped on the ink ejection surface 124 since the ink ejection surface 124 has received a liquid-repelling (liquid-phobic) treatment. Therefore, provided that the liquid-phobic treatment on the ink ejection surface 124 is uniform, the ink which has bled out from the nozzle 51 will spread out uniformly in a radiating fashion from the nozzle 51.

In the present embodiment, the positive pressure applied by the back pressure adjustment pump 104 is greater than the variation range of the pressure loss due to the variations in the flow channel resistances of the respective nozzles. The pressure applied to each of the nozzles is thus substantially the same. Therefore, in each of the nozzles 51, it is possible to make the ink spread out to substantially the same range centered on the nozzle, in a prescribed time period.

Moreover, if a non-ejection drive waveform having a maximum voltage of 30V as shown in FIGS. 8A and 8B, which causes a meniscus projection amount of 30 μm, is applied in a state where the internal pressure of the head in the standby state is maintained as described above, then uniform bleeding of the ink from the nozzles is achieved. In other words, in a state where the internal pressure of the head in the standby state was maintained, the maximum voltage of the non-ejection drive waveform which achieved uniform bleeding of the ink from the nozzles was 30V.

In the state shown in FIG. 7C, if a positive pressure of a prescribed magnitude is maintained for 5 seconds after the application of the non-ejection drive waveform, then the width (diameter) of the ink which has spread out in a radiating fashion on the ink ejection surface 124 is 2 mm, for example. In other words, it is possible to make the ink spread to a range having a radius of 1 mm, centered on the nozzle 51 from which the ink has bled out. The planar shape of the ink which has spread out onto the ink ejection surface 124 is considered to be substantially a circular shape, provided that the liquid-phobic treatment on the ink ejection surface 124 is uniform.

After the clip point 126 of the meniscus 122 has been moved to the outside of the nozzle 51, by maintaining the positive pressure applied to the ink inside the nozzle 51 for a prescribed period of time, it is possible to cause the ink which has bled out onto the ink ejection surface 124 from the nozzle 51 to spread uniformly over the ink ejection surface 124, as shown in FIG. 7C, regardless of the variations in the flow channel resistances of the respective nozzles.

By causing the ink which has bled out from the nozzles 51 onto the ink ejection surface 124 to spread out over the ink ejection surface 124, it is possible to reduce the adhesive force of the adhering material which is attached to the ink ejection surface 124 by making the ink (ink solvent) come into contact with the adhering material, and furthermore, it is also possible to dissolve any cured ink in the adhering material and therefore removal of the adhering material is facilitated.

In the ink ejection surface maintenance control described in the present embodiment, after spreading the ink uniformly over the ink ejection surface 124 (to a range of the same size centered about each nozzle, within a prescribed time), the ink which has spread over the ink ejection surface 124 is wiped and removed with the blade 66 (see FIG. 5).

In the present embodiment, the time period from the application end timing of the non-ejection drive signal until the start timing of the wiping operation by the blade 66 is managed by means of the timer 96 shown in FIG. 5. In other words, the time period (the standby duration) during which the ink spreads over the ink ejection surface 124 is set, the elapsed time from the application end timing of the non-ejection drive signal is measured by the timer 96, and when the prescribed standby duration has elapsed after the application end timing of the non-ejection drive signal, (in other words, if the measurement value of the timer 96 exceeds the prescribed standby duration), then the wiping operation of the blade 66 is started. In the state shown in FIG. 7C, the set value of the standby duration is 5 seconds, and the ink spreads to a range having a radius of 1 mm centered on the nozzle 51.

Furthermore, by setting the prescribed time period from the application end timing of the non-ejection drive signal until the start of the wiping operation of the blade 66, it is possible to ensure sufficient time to dissolve the solidified ink which is attached to the ink ejection surface 124, and the removal of the solidified ink attached to the ink ejection surface 124 is facilitated.

When the wiping operation of the ink ejection surface 124 is started by the blade 66 shown in FIG. 5, the back pressure adjustment pump 104 shown in FIG. 5 is halted, the sub tank 100 is opened to the air by opening the air connection valve 106, and the internal pressure (back pressure) of the head 50 is thereby changed from a positive pressure to atmospheric pressure. In this case, the spreading of the ink on the ink ejection surface 124 is halted, and the ink is maintained in a spread state on the ink ejection surface 124. The relationship between the internal pressure of the head 50 (the positive pressure or negative pressure) and the atmospheric pressure during the ejection standby and positive pressure application described above is as follows: negative pressure<atmospheric pressure<positive pressure.

By maintaining the internal pressure of the head 50 at atmospheric pressure during the wiping operation by the blade 66, the ink which has spread on the ink ejection surface 124 is prevented from flowing back into the nozzles 51, and leaking of ink from the nozzles 51 after wiping is also prevented.

When the wiping operation of the blade 66 is halted, the atmosphere connection valve 106 in FIG. 5 is closed, and the back pressure adjustment pump 104 is operated, thereby changing the internal pressure of the head 50 back to a negative pressure.

A desirable mode is one in which, when the wiping operation of the ink ejection surface 124 by the blade 66 has completed, a preliminary ejection is carried out, and foreign matter which has entered into the nozzles 51 is removed, as well as shaping again the meniscus surfaces in the respective nozzles 51.

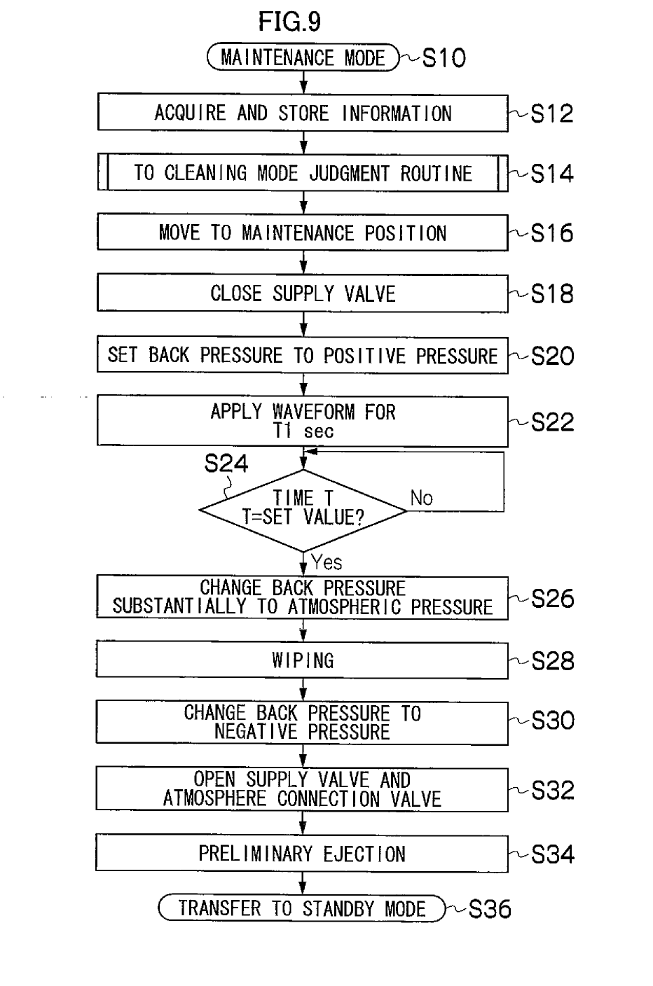

FIG. 9 is a diagram showing a flowchart of the ink ejection surface maintenance control described in the present embodiment. As shown in FIG. 9, when the control procedure of the inkjet recording apparatus 10 advances to maintenance control (step S10), various elements of information, such as the ink information, the environmental information, the use frequency information, and the like, are acquired, and these information elements are stored (step S12).

The ink information may be obtained from an information storage body attached to the ink tank 60 shown in FIG. 5 (for example, an IC tag, barcode, or the like), or it may be input directly by the user (selected from a list of options) by means of a user interface. The ink information includes information on the physical properties of the ink, such as the viscosity of the ink, the density of the ink, and the use start time, the date of manufacture, the remaining amount, and the like.

For example, when using an ink of high viscosity, since the amount of protuberance of the meniscus is small compared to a case where an ink of low viscosity is used, then depending on the viscosity of the ink, either the internal pressure of the head 50 is set to a more positive pressure (a higher pressure), or the waveform application time is increased, in such a manner that amount of protuberance of the meniscus does not vary. Similarly, in the case of ink where a long time has elapsed since the use start date or the date of manufacture, or if the remaining amount of ink is low, then it is considered that the viscosity of the ink will be relatively high, and therefore similarly to the case of using an ink of high viscosity, either the internal pressure of the head 50 is set further to the positive pressure side, or the waveform application time is lengthened. Furthermore, in the case of an ink of high density, since the viscosity of the ink is more liable to rise, then similarly to the case of using an ink of high viscosity, either the internal pressure of the head 50 is set further to the positive pressure side, or the waveform application time is lengthened. Moreover, in the case of an ink having a low surface tension, the ink is more liable to spread over the nozzle surface, and therefore either the waveform application time is shortened or the standby duration (the standby duration until wiping) is shortened.

The environmental information is chiefly related to the temperature and the humidity in the vicinity of the ink ejection surface 124 of the head 50, and this information is acquired by the temperature sensor 92 and the humidity sensor 94 shown in FIG. 6. For example, if the temperature has become low, then the viscosity of the ink inside the nozzles 51 rises, and therefore either the internal pressure of the head 50 is set further to the positive pressure side, or the waveform application time is lengthened. Moreover, if the humidity becomes low, then there are concerns about increase in the viscosity of the ink inside the nozzles 51, and therefore similarly to a case of using an ink of high viscosity, either the internal pressure of the head 50 is set further to the positive pressure side, or the waveform application time is lengthened.

The use frequency information includes information concerning the use conditions (type and size of recording media used, number of sheets, etc.), the error history, the ejection failure history, and the like, which is stored in a storage region (storage medium). The required information is read out as and when necessary from the recording region.

When the required information has been acquired and this information has been stored at step S12, the cleaning mode (maintenance mode) is judged on the basis of this information (step S14). In other words, the viscosity inside (the nozzles 51 of) the head 50 is judged on the basis of the various information elements which were acquired at step S10 and recorded at step S12, and the cleaning mode is judged on the basis of the judgment results. To give an example of one mode of judging the viscosity of the ink inside the head 50 from the various information elements described above, there is a mode in which the relationship between the information elements and the viscosity is stored in advance in the form of a data table, with respect to each type of ink.

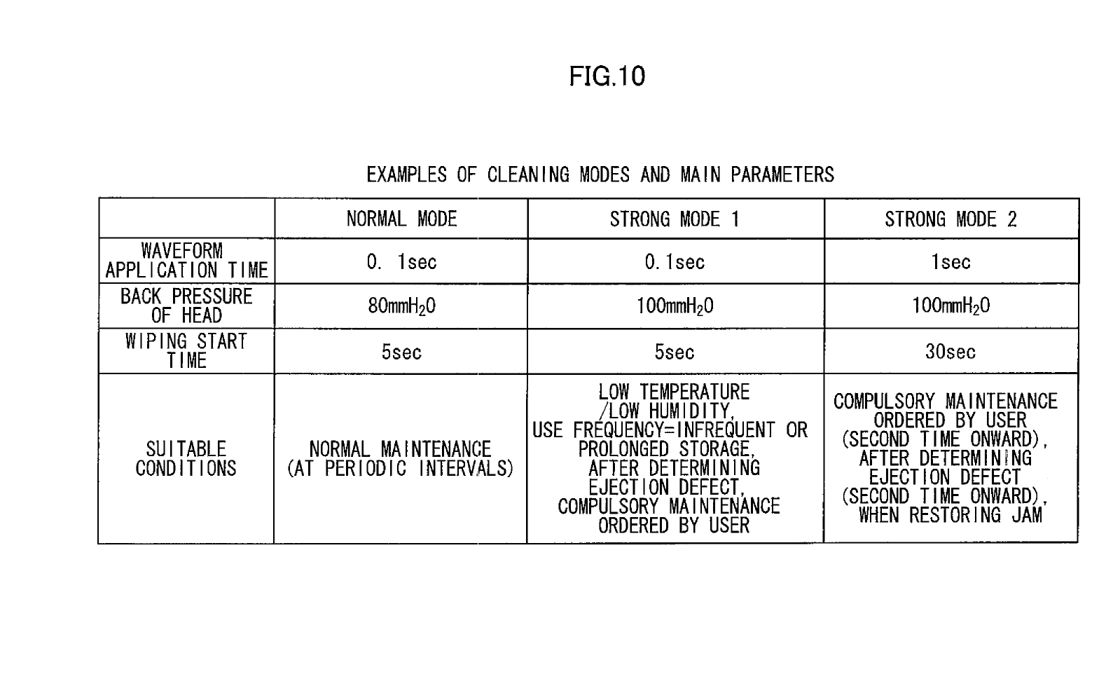

FIG. 10 is a diagram showing one example of a cleaning mode which is judged at step S14.

The ink ejection surface maintenance control procedure described in the present embodiment is composed so as to be able to switch between three modes shown in FIG. 10. These modes are divided broadly into “normal mode” and “strong mode”. The “strong mode” is divided further into “strong mode 1” and “strong mode 2”. The “strong mode” may be constituted of only one type of strong mode, but by adopting a composition which includes a plurality of strong modes, which can be selected appropriately according to requirements, it is possible to use a suitable mode according to the conditions, and hence the cleaning of the ink ejection surface 124 can be improved (adhering material on the ink ejection surface 124 can be removed reliably), as well as saving ink (reducing the amount of ink consumed in cleaning the ink ejection surface 124).

If the soiling is estimated to be relatively light, then the modes can be implemented independently, whereas if the amount of soiling is estimated to be relatively heavy, then it is possible to implement a plurality of modes in combination. For example, a mode is possible where, in a case where sufficient effects are not obtained by means of one operation of the normal mode, then one operation of a strong mode is further implemented to carry out the cleaning of the ink ejection surface 124 for the second time.

The “normal mode” shown in FIG. 10 is adopted for periodic cleaning of the ink ejection surface 124. Periodic cleaning is cleaning that is carried out when a prescribed amount of time has elapsed since the previous cleaning operation, or cleaning that is carried out when a prescribed number of sheets have been printed since the previous cleaning operation.

When cleaning the ink ejection surface 124 more strongly than in the normal mode, the “strong mode” is adopted. One example of a case where the “strong mode” is used is when there is increase in the viscosity of the ink inside the nozzles (namely, a viscosity which exceeds the standard ink viscosity range). In other words, the “strong mode” is adopted, for instance, when the apparatus is used in a low-temperature environment or in dry (low-humidity) conditions, when the use frequency is low or the apparatus is unused for a long period, when a restoration operation is performed after discovering a nozzle suffering an ejection abnormality, or when requested by the user.

FIG. 10 shows an example of the selective use of a plurality of strong modes in which a “strong mode 1” and a “strong mode 2” are provided. The “strong mode 2”, which is a cleaning mode that is even stronger than the strong mode 1, is used either when the cleaning effects have been insufficient with the “strong mode 1”, in a case where an ejection abnormality nozzle has been discovered or when a user request has been issued, or when it is judged that the cleaning effects of the “strong mode 1” will be insufficient, in the case of a restoration operation after the printer jam occurs, or if a plurality of conditions coexist, for instance.

For example, when the printer jam occurs, the head continues in a state with the cap (reference numeral 64 in FIG. 5) removed (namely, the ink ejection surface 124 cannot be protected by the cap 64), and hence there is a concern that increase in the viscosity of the ink inside the nozzles 51 will increase and air bubbles will enter into the head 50 via the nozzles 51. Moreover, there is a possibility that a similar problem may arise in a state where the cap 64 cannot be placed in position due to interposing paper, or the like. In cases of this kind, by using “strong mode 2”, the ink of increased viscosity or gas bubbles inside the nozzles 51 are expelled to the exterior of the head 50.

In other words, in the “strong mode 2”, the waveform application time and the wiping start timer are increased with respect to the “strong mode 1”, with the object of expelling the ink of increased viscosity and the gas bubbles inside the nozzles 51, to the exterior of the head 50. Furthermore, in the case of ejection failures or ejection abnormalities (for example, ejection direction abnormalities) which cannot be resolved by “strong mode 1”, there is a possibility that dirt or solidified ink adhering to the vicinity of the nozzles 51 will not be removed, and therefore, in “strong mode 2”, the wiping start timer is extended in order to promote the dissolution of solidified material and the detachment of dirt particles.

As shown in FIG. 10, the parameters that are different between the three cleaning modes are the application time (waveform application time period) of the non-ejection drive signal, the internal pressure of the head 50, and the standby duration after application of the non-ejection drive signal (wiping start timer). By appropriately modifying these parameters, desirable cleaning of the ink ejection surface 124 can be achieved.

For example, the application time of the non-ejection drive signal is set to 0.1 seconds in “normal mode” and “strong mode 1”, and is set to 1 second in “strong mode 2”. The object of applying a non-ejection drive signal is to move the boundary of the meniscus 122 from the interior of the nozzles 51 onto the ink ejection surface 124, and in the case of “normal mode” and “strong mode 1”, this signal is applied for a short time only. In the present embodiment, taking account of the variation in the amount of ink projecting from the openings of the respective nozzles 51, the application time of the non-ejection drive signal is set to 0.1 seconds.

On the other hand, in “strong mode 2”, the application time of the non-ejection drive signal is set to 1 second, which is longer than in “normal mode” or “strong mode 1”. “Strong mode 2” is used in a state where there is increase of the viscosity of the ink inside the nozzles 51, and since the speed of movement of the meniscus upon application of the non-ejection drive signal tends to decline as the viscosity of the ink increases, then by setting the application time of the non-ejection drive signal to 1 second, which is longer than in the other modes, it is possible to make the boundary 127 of the meniscus 122 move reliably onto the ink ejection surface 124.

In the “strong mode 2”, if the application time of the non-ejection drive signal is even longer than 1 second, then it is possible to make the boundary of the meniscus 122 move even more reliably over the ink ejection surface 124. However, when the application time of the non-ejection drive signal is 10 seconds or longer, little additional effect in moving the boundary of the meniscus 122 over the ink ejection surface 124 is obtained, whereas on the other hand, there is an increase in the amount of power consumed by the application of the non-ejection drive signal. Consequently, in seeking to achieve a balance between the effect of moving the boundary of the meniscus 122 onto the ink ejection surface 124 and the increase in the power consumption caused by the application of the non-ejection drive signal, it is desirable that the application time of the non-ejection drive signal should be no more than 10 seconds at maximum.

Furthermore, the internal pressure of the head 50 is set to 80 mm H₂O in “normal mode” and 100 mm H₂O in “strong mode 1” and “strong mode 2”. When the internal pressure of the head 50 is relatively low, the speed at which the ink spreads over the ink ejection surface 124 is also relatively slow. On the other hand, when the internal pressure of the head 50 exceeds a prescribed value, then the meniscus 122 breaks down and the ink which has bled out from the nozzles 51 is no longer able to be controlled by means of the internal pressure of the head 50. Hence, the internal pressure of the head 50 is set in a pressure range from a pressure at which sufficient ink speed is obtained to a pressure which does not cause the meniscus to break down. In the present embodiment, the internal pressure of the head in “strong mode 1” and “strong mode 2” is set approximately 25% higher than the internal pressure of the head 50 in “normal mode”, in such a manner that gas bubbles which cannot be expelled in “normal mode” can be expelled in “strong mode 1” and “strong mode 2”.

In other words, if the internal pressure of the head 50 becomes low, then the effects of the variations in flow channel resistances between the respective nozzles are liable to become apparent, and in particular, if gas bubbles have entered inside the nozzles 51 when the jam has occurred, or the like, then if the internal pressure of the head 50 is low, the gas bubbles will become problematic. Therefore, the internal pressure of the head 50 is set to a higher pressure in the “strong mode 1” and “strong mode 2” than in the “normal mode”.

Furthermore, it is also considered the occurrence of the printer jam can lead to ink and dirt becoming attached to positions distant from the nozzles 51. If the internal pressure of the head 50 is low, then the wetting and spreading of the ink after moving the clip point will be insufficient (the ink takes time to spread to positions distant from the nozzles 51), and therefore the internal pressure of the head 50 is set to a high pressure in order to be able to make the ink spread rapidly from the nozzles 51 to positions distant from the nozzles 51, thereby preventing situations where the ink ejection surface 124 is wiped before the ink has wet and spread and hence damage is caused to the liquid-phobic film on the ink ejection surface 124. A desirable mode is one where the wiping start timer is also increased, at the same time.

The standby duration from the application end timing of the non-ejection drive signal is 5 seconds in “normal mode” and “strong mode 1”, and is set to 30 seconds in “strong mode 2”, which carries out cleaning more strongly than in “normal mode” and “strong mode 1”. In “normal mode” and “strong mode 1”, the standby duration from the application end timing of the non-ejection drive signal is set to 5 seconds, which is the time period such that the ink that has bled out from the respective nozzles to spread out onto the ink ejection surface 124 but not to come into contact with the ink that has bled out from the adjacent nozzle. Furthermore, in “strong mode 2”, in order that the ink inside the nozzles can move out and away from the nozzles (in other words, in order to cause the ink to spread rapidly to positions distant from the nozzles), the standby duration from the application end timing of the non-ejection drive signal is set to 30 seconds. Desirably, the standby duration from the application end timing of the non-ejection drive signal is previously optimized in accordance with the surface treatment of the nozzles 51, the shape of the nozzles 51, the surface treatment of the ink ejection surface 124, and the distance between adjacent nozzles, (namely, the standby duration from the application end timing of the non-ejection drive signal is preferably optimized in advance by experimentation or simulation, or the like).

If the standby duration from the application end timing of the non-ejection drive signal becomes long, then the ink which has bled out from the nozzles and has then spread out comes into mutual contact and combines with each other, and there is a possibility that this ink may drip off from the ink ejection surface 124. Therefore, a desirable mode is one in which an ink receptacle (for example, the cap 64 in FIG. 5) having a size which corresponds to the size of the ink ejection surface 124 (the nozzle forming region where the nozzles 51 are formed) is provided at a position opposing the ink ejection surface 124 of the head 50, during ink ejection surface maintenance control procedure.

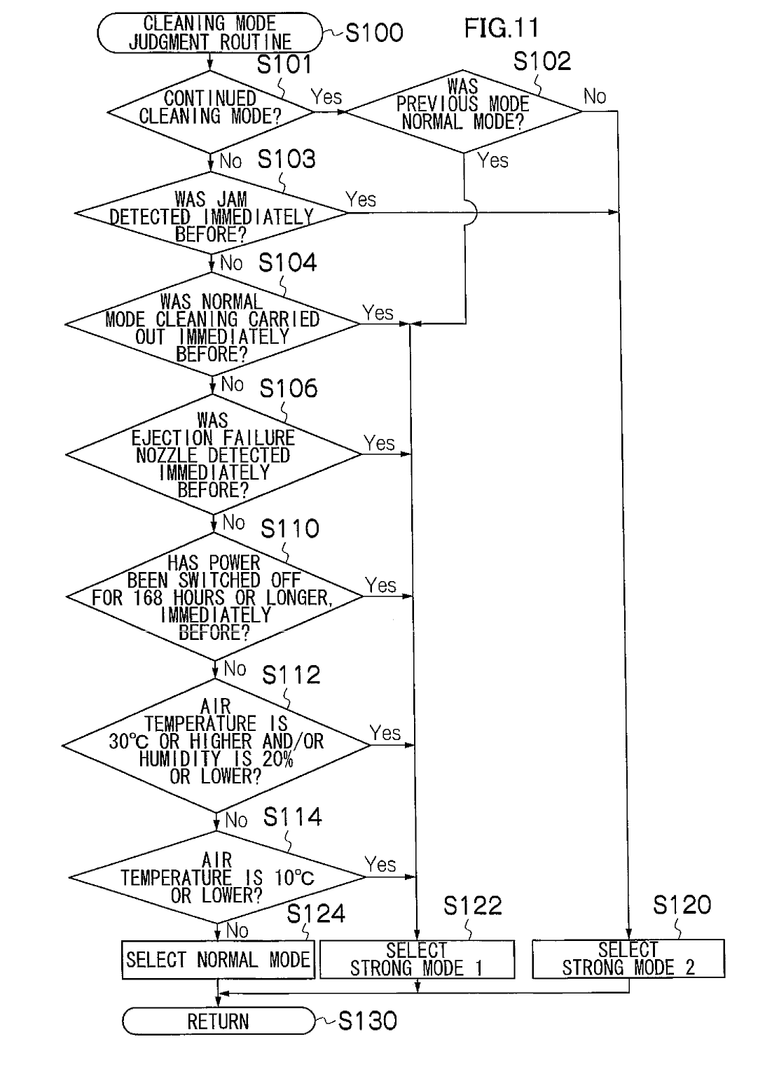

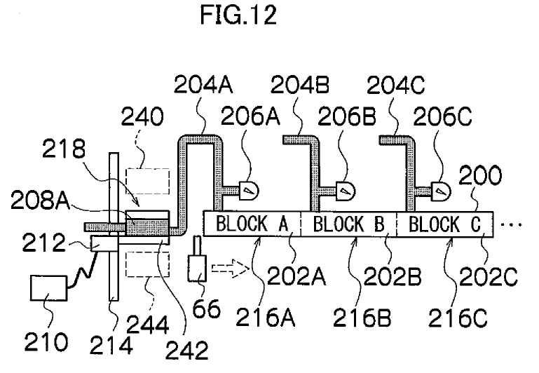

FIG. 11 is a diagram showing a flowchart of a cleaning mode judgment routine (step S14 in FIG. 9).

When the cleaning mode judgment routine shown in FIG. 11 is started (step S100), it is judged whether or not it is a continued cleaning mode (step S101).

Here, “continued cleaning mode” indicates a case where a further cleaning mode is carried out after the completion of a previous cleaning mode, without performing a printing operation, switching off the power, or transferring to power-saving mode.

Furthermore, “power-saving mode” indicates a mode where there has been no print request after a state such as standby mode has continued for a prescribed period of time (in the present embodiment, 1 minute), and where the ink ejection surface 124 of the head 50 is capped and the supply of power to the components which do not require continuous power supply (for example, motors) is halted.

If it is judged at step S101 that the mode is the continued cleaning mode (YES verdict), then the procedure advances to step S102, and it is judged whether or not the “normal mode” has been implemented in the previous operation of the ink ejection surface maintenance control procedure.

At step S102, if it is judged that the “normal mode” has been carried out the last time that the ink ejection surface maintenance control procedure was implemented (YES verdict), then the “strong mode 1” is selected as the current cleaning mode, whereas if it is judged that the “strong mode 1” or “strong mode 2” was carried out the last time that the ink ejection surface maintenance control procedure was implemented (NO verdict), then the “strong mode 2” is selected as the current cleaning mode.

On the other hand, if it is judged at step S101 that the mode is not the continued cleaning mode (NO verdict), then it is judged whether or not the jam has been determined immediately before the current ink ejection surface maintenance control procedure (step S103).

If it is judged at step S103 that the jam has been determined immediately before the current ink ejection surface maintenance control procedure (YES verdict), then the current cleaning is set to the “strong mode 2” (step S122), and if it is judged that the jam was not determined immediately before the current ink ejection surface maintenance control procedure (NO verdict), then the procedure advances to step S104.

At step S104, it is judged whether or not the “normal mode” has been carried out immediately before the current ink ejection surface maintenance control procedure, and if it is judged that the “normal mode” has been carried out immediately before the current ink ejection surface maintenance control procedure (YES verdict), then the “strong mode 1” is selected as the current cleaning mode (step S122). On the other hand, if it is judged that the “normal mode” has not been carried out immediately before the current ink ejection surface maintenance control procedure (NO verdict), then it is judged whether or not the ejection abnormality has been determined immediately before the current ink ejection surface maintenance control procedure (step S106).

If, at step S106, it is judged that the ejection abnormality has been determined immediately before the current ink ejection surface maintenance control procedure (YES verdict), then the “strong mode 1” is selected as the current cleaning mode. On the other hand, if, at step S106, it is judged that the ejection abnormality has not been determined immediately before the current ink ejection surface maintenance control procedure (NO verdict), then it is judged whether or not there has been a state of prolonged storage immediately before the current ink ejection surface maintenance control procedure (step S110).

Here, the “state of prolonged storage” in step S110 is, for example, a case where a power off state has continued for a prescribed period of time or longer, and in the present embodiment, a case where a power off state has continued for 168 hours (1 week) or longer is taken to be a “state of prolonged storage”. When the power is switched off, the ink ejection surface is hermetically sealed with the cap, or a state close to hermetic sealing is created due to the presence of the atmosphere connection valve. But unlike complete hermetic sealing, when a prescribed period of time has elapsed, the ejection abnormalities can become a problem due to increase in the viscosity of the ink at the meniscus inside the nozzles. It is possible to extend the period of time that elapses until the ejection abnormalities occur due to increase in the viscosity, by appropriately devising the seal of the cap or improving the sealing force, or the like. However, taking account of cost considerations and conditions such as the frequency of use by the operator, it is decided that maintenance of the head is carried out when the power is switched on after having continued on a power off state for 168 hours or longer.

If, at step S110, it is judged that a power off state has continued for 168 hours or longer immediately before the current ink ejection surface maintenance control procedure, then the “strong mode 1” is selected as the current cleaning mode (step S122). On the other hand, if, at step S110, it is judged that a power off state has not continued for 168 hours or longer immediately before the current ink ejection surface maintenance control procedure (NO verdict), then the operating environment conditions are judged (step S112).

At step S112, it is judged whether or not the operating environment conditions of an air temperature of not lower than 30° C. or a humidity of not greater than 20% are satisfied. If it is judged that the air temperature is not lower than 30° C. or the humidity is not greater than 20% (YES verdict), then the viscosity of the ink is considered to be increased due to the evaporation of the solvent in the ink, and hence the current cleaning mode is set to the “strong mode 1”. On the other hand, in the case of operating environment conditions where the air temperature is lower than 30° C. and the humidity exceeds 20% (NO verdict), then it is judged whether or not the air temperature is 10° C. or lower (step S114).

If, at step S114, it is judged that the air temperature is 10° C. or lower (YES verdict), then the viscosity of the ink is considered to be increased due to the low temperature, and hence the current cleaning mode is set to the “strong mode 1” (step S122). On the other hand, if the air temperature is greater than 10° C. (and less than 30° C.) (NO verdict), then the current cleaning mode is set to the “normal mode” (step S124).

The ink viscosity range that allows the ink to be ejected is determined in accordance with the ejection force of the head and the physical properties of the ink, and the like. It is determined how far the viscosity has increased at the meniscus in the head, on the basis of conditions such as the environment (temperature, humidity), the nozzle opening diameter, the number of sheets printed, and the like. Furthermore, the tolerable range of the viscosity is determined in accordance with the volume of ink ejected from the head, and in the present embodiment, the temperature and humidity conditions are determined by taking account of the conditions described above.

FIG. 11 shows an example of a mode where, in the current ink ejection surface maintenance control procedure, judgments are made successively with regard whether or not an ejection abnormality has been determined, whether or not a jam has been determined, and whether or not the apparatus has been stored for a long time, and the environmental conditions are within a prescribed range. However, it is also possible to adopt a composition in which these judgments are processed in parallel and the cleaning mode is set to the “strong mode 2” if a plurality of these conditions are satisfied.

When the cleaning mode for the current ink ejection surface maintenance control procedure has been set by the steps described above, the processing returns from the cleaning mode judgment routine shown in FIG. 11 to the main routine shown in FIG. 9 (step S130 in FIG. 11). Although not shown in FIG. 11, if the cleaning mode is selected on the basis of a user request, then the cleaning mode for the current ink ejection surface maintenance control procedure is set obligatorily to the selected cleaning mode.

After returning to the main routine in FIG. 9, preparatory steps are carried out in the respective sections of the inkjet recording apparatus 10, in order to carry out a maintenance operation for the head 50 (step S16). The preparatory steps shown in step S16 include a step of moving the head 50 to a maintenance position (in other words, a step of withdrawing the respective sections that has been disposed in the peripheral region of the head 50 during a printing operation).

When the preparations for the maintenance operation of the head 50 have been completed, the supply valve 63 and the atmosphere connection valve 106 in FIG. 5 are closed (step S18 in FIG. 9), and the back pressure adjustment pump 104 in FIG. 5 is operated in such a manner that the internal pressure of the head 50 assumes a pressure value in accordance with the set cleaning mode (step S20). In other words, in the head internal pressure changing step carried out at step S20, the operation of the back pressure adjustment pump 104 is controlled while referring to the value of the pressure gauge 108 in FIG. 5, in such a manner that the pressure gauge 108 maintains a target value.

When the internal pressure of the head 50 has changed to the target value at step S20, a non-ejection drive signal is applied to the piezoelectric elements 58 corresponding to the respective nozzles 51 (step S22). The application time T1 used for the non-ejection drive signal is the value based on the cleaning mode which has been selected in the cleaning mode judgment routine.

When the non-ejection drive signal is applied to the piezoelectric elements 58 corresponding to the respective nozzles 51, the elapsed time T from the application end timing of the non-ejection drive signal is measured by the timer 96 in FIG. 6, and this elapsed time T from the application end timing of the non-ejection drive signal as measured by the timer 96 is compared with the established standby duration (set value) from the application end timing of the non-ejection drive signal (step S24).

At step S24, if the elapsed time T from the application end timing of the non-ejection drive signal is less than the established standby duration from the application end timing of the non-ejection drive signal (NO verdict), then the counting of the elapsed time T from the application end timing of the non-ejection drive signal is continued. On the other hand, if the elapsed time T from the application end timing of the non-ejection drive signal becomes equal to or greater than the established standby duration from the application end timing of the non-ejection drive signal (YES verdict), the procedure advances to step S26.

At step S26, the atmosphere connection valve 106 in FIG. 5 is opened, the internal pressure of the head 50 is changed to atmospheric pressure (step S26 in FIG. 9), and the wiping process of the ink ejection surface 124 is started by operating the blade 66 (step S28). When the wiping process of the ink ejection surface 124 using the blade 66 has been completed, the atmosphere connection valve 106 in FIG. 5 is closed, the back pressure adjustment pump 104 is operated, and the internal pressure of the head 50 is changed to a negative pressure (step S30 in FIG. 9).

Thereupon, the supply valve 63 and the atmosphere connection valve 106 in FIG. 5 are opened (step S32), preliminary ejection is carried out by the head 50 (step S34), and the present ink ejection surface maintenance control procedure terminates. The procedure then transfers to standby mode (step S36).

In the inkjet recording apparatus 10 having the composition described above, the non-ejection drive signal is applied to the piezoelectric elements 58 corresponding to the nozzles while maintaining a state where the internal pressure of the head 50 is adjusted to the positive pressure and the ink has been caused to project to the outside of the openings of the nozzles 51. Therefore, it is possible to cause the ink to bleed out from the nozzles 51 onto the ink ejection surface 124. In other words, by adjusting the internal pressure of the head 50 to the positive pressure and by combining the application of pressure due to the supply of the non-ejection drive signal, then even if there are variations in the amounts of protuberance of the ink which projects out beyond the openings of the nozzles 51, the assistance provided by the operation of the piezoelectric elements 58 due to the application of the non-ejection drive signal makes it possible to cause the ink 120 inside the nozzles 51 to move out reliably onto the ink ejection surface 124.

Moreover, since the internal pressure of the head 50 is controlled so as to maintain the positive pressure during a prescribed standby duration from the timing at which the non-ejection drive signal is applied, then the ink which has bled out from the nozzles 51 spreads out uniformly on the ink ejection surface 124 and arrives at positions which are distant from the nozzles 51, and hence the regions of the ink ejection surface 124 which are distant from the nozzles 51 can be wetted. Consequently, the ink which has spread out over the ink ejection surface 124 makes contact with the adhering material that is attached to positions distant from the nozzles 51, and therefore the adhering material can be made to dissolve into the ink solvent, the adhesive force of the adhering material can be weakened, and hence it becomes easier to remove the adhering material.

Since wiping by the blade 66 is carried out in a state where ink has spread over the ink ejection surface 124, then a wet wiping operation is performed and deterioration of the ink ejection surface 124 or blade 66 caused by wear can be reduced. Furthermore, since the removal of adhering material is facilitated by causing the ink to spread out over the ink ejection surface, then it is possible to reduce the pressure applied by the blade 66 to the ink ejection surface 124, and therefore longer life can be expected in the blade 66 and the liquid-phobic treatment on the ink ejection surface.

Since wiping of the ink ejection surface 124 by the blade 66 is carried out after the internal pressure of the head 50 has been changed from the positive pressure to the atmospheric pressure and the spreading of the ink on the ink ejection surface 124 has been halted, then reverse flow of ink into the nozzles 51 or infiltration of gas bubbles into the nozzles 51 is prevented, and furthermore, leaking of ink from the ink ejection surface 124 can also be prevented.

Since a plurality of cleaning modes are provided and the cleaning mode can be switched according to the conditions of use and the operating environment of the head 50, and the type (physical properties) of the ink, then it is possible to achieve highly effective and efficient cleaning of the ink ejection surface 124.

The present embodiment has been described above with reference to an embodiment in which the pressure inside the sub tank 100 is raised or reduced by means of the pump 104, as a device for changing the internal pressure of the head 50, and furthermore, the pressure of the head 50 is changed from the negative pressure to the positive pressure, from the positive pressure to the atmospheric pressure, and from the atmospheric pressure to the negative pressure by opening and closing a valve which allows the sub tank 100 to be connected to the atmosphere. However, as the device for changing the internal pressure of the head 50, it is also possible to adopt a mode in which the internal pressure of the head 50 is changed by adjusting the liquid head pressure differential between the head 50 and the sub tank 100 (ink tank 60) that is open to the atmosphere (as described in the second embodiment below), and it is also possible to adopt a mode in which the ink tank 60 is formed in the shape of a bag and the internal pressure of the head 50 is changed by adjusting the pressure applied to the bag-shaped ink tank.

### Second Embodiment

Next, a second embodiment of the present invention will be described. FIG. 12 is a structural diagram showing the approximate composition of a portion of a head 200 and an ink supply system according to a second embodiment of the present invention. In this second embodiment, parts which are the same as or similar to the first embodiment described above are labeled with the same reference numerals and further explanation thereof is omitted here.

The head 200 shown in FIG. 12 is constituted of a plurality of head blocks (corresponding to “nozzle block) 202 (202A, 202B, 202C, . . . ) and the respective head blocks 202 are arranged in one row in the breadthways direction of the recording paper 16. FIG. 12 depicts three head blocks, but it is possible to provide a greater number of head blocks, and it is also possible to provide two head blocks.

Ink supply channels 204 (204A, 204B, 204C, . . . ) are connected respectively to the head blocks 202, and pressure gauges 206 (206A, 206B, 206C, . . . ) are respectively provided for the ink supply channels 204. Furthermore, sub tanks 208 (208A, 208B, 208C, . . . ; FIG. 12 only depicts the sub tank 208A which is connected to the head block 202A) are respectively provided on the opposite side of the ink supply channels 204 with respect to the head blocks 202. Although not shown in FIG. 12, the sub tank 208 in FIG. 12 is connected to a main tank, via a supply valve, a filter unit and a supply pump, similarly to the ink supply system shown in FIG. 5. By means of this configuration, when the supply valve is opened and the supply pump is operated, the ink is supplied from the main tank to the sub tank 208 via the filter unit.

The sub tank 100 shown in the present embodiment is composed so as to be movable along a vertical guide 214 in the vertical direction (the direction which is perpendicular to the ink ejection surface 216 of the head 200) by operating an elevator mechanism 212 by means of drive energy supplied by a drive source 210 (which corresponds to the motor 88 in FIG. 6). Furthermore, the sub tank 208 has an atmosphere connection port 218 which connects the ink inside the sub tank 208 to the atmosphere, thereby achieving a composition whereby the internal pressure of the head block 202 can be adjusted by moving the sub tank 208 upwards or downwards and thereby changing the liquid head pressure differential generated between the sub tank 208 and the head block 202.

In other words, the head 200 shown in FIG. 12 is composed in such a manner that the internal pressure of the head 200 can be adjusted independently in each head block 202, and a maintenance operation can be carried out independently in each head block 202.

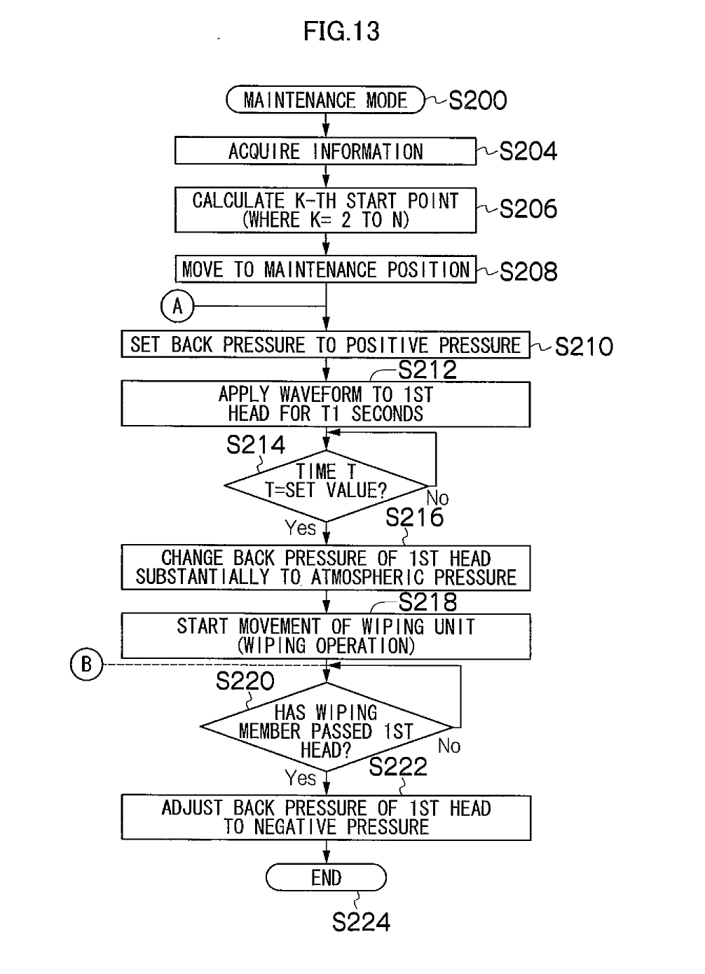

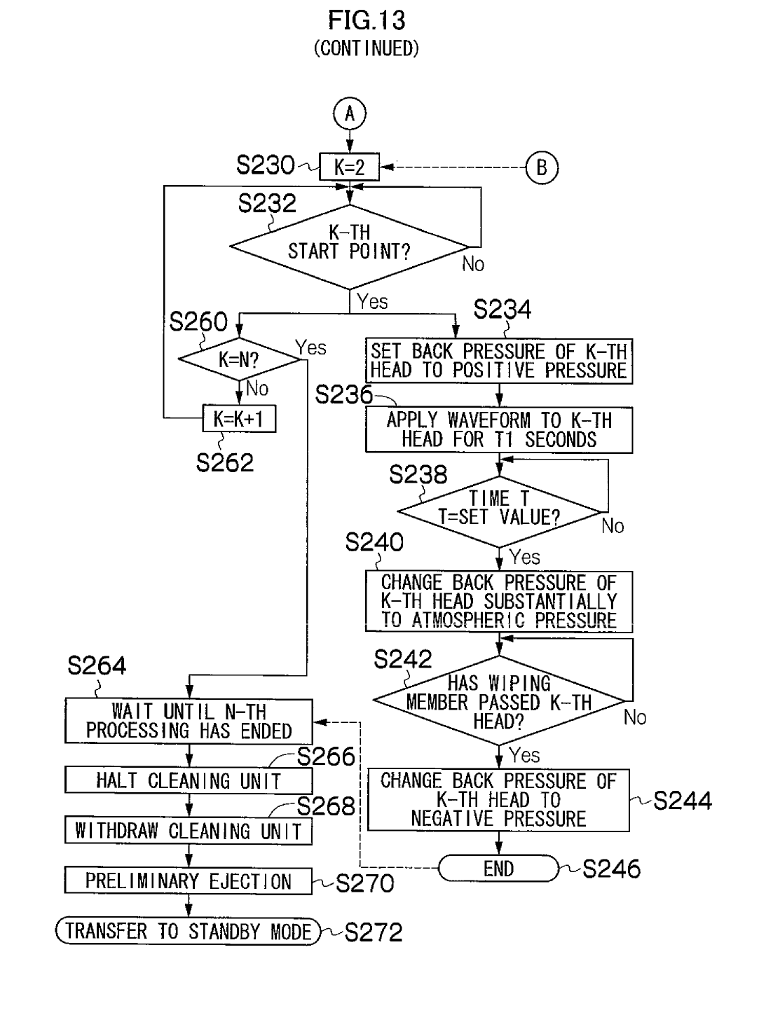

FIG. 13 is a diagram showing a flowchart of the ink ejection surface maintenance control procedure relating to the second embodiment of the present invention. The differences with respect to the ink ejection surface maintenance control procedure according to the first embodiment described above are as follows. Firstly, in the second embodiment, the internal pressure is changed independently in each of the head blocks 202 and that the non-ejection drive signal is applied independently to each of the head blocks 202. Secondly, in the second embodiment, the internal pressures of the head blocks 202 and the application of the non-ejection drive signal are controlled in accordance with the movement of the blade 66.

During a wiping operation, the blade 66 is moved in the lengthwise direction of the head 200 (from left to right in FIG. 12), and the ink ejection surface 216 is wiped throughout the whole length of the head 200 in the lengthwise direction thereof, in the order of the head block 202A, the head block 202B and the head block 202C.

For example, if the blade 66 has a length which corresponds to the length of the head 200 in the breadthways direction (the direction perpendicular to the direction of movement of the blade 66), then by moving the blade 66 and the head 200 just once relatively in the lengthwise direction of the head 200, it is possible to wipe the whole of the ink ejection surface of the head 200.

A mode in which the blade 66 has a length corresponding to the breadthways dimension of the head 200, in the breadthways direction (the direction perpendicular to the direction of movement of the blade 66) of the head 200 may be a mode which uses one blade having this length, or a mode which combines a plurality of short blades which are each shorter than this length.

The sequence of the ink ejection surface maintenance control procedure is described now with reference to FIG. 13. When the maintenance mode is started, automatically or in response to a user request (step S200), information such as the ink information, environment information and use frequency information are acquired, and the acquired information is stored (step S204). The respective information elements which are acquired and stored at step S204 are the same as those of the first embodiment which was described above, and further explanation thereof is omitted here.

Thereupon, the wiping start position (start point) of the blade 66 corresponding to the k-th head block (k=2, 3, 4, . . . N) is calculated. The calculation of the wiping start position is performed for the head blocks sequentially, from the 2nd head block to the Nth head block (step S206).

Here, the number “k” indicates the order of the wiping operation to be performed by the blade 66. In other words, the second head block (k=2) is the head block 202B in FIG. 12, and the third head block (k=3) is the head block 202C.

In the step S206, the timing for changing the internal pressure of the second and subsequent head blocks from the negative pressure to the positive pressure is also calculated on the basis of the speed of movement of the blade 66. The timing for changing the internal pressure (from the negative pressure to the positive pressure) of the k-th head block (k=2, 3, 4, . . . N) is stored as the position on the (k−1)-th head block. In other words, when the blade 66 passes by the stored position on the first head block 202A, the internal pressure of the second head block 202B is changed from the negative pressure to the positive pressure in order to protrude the ink inside the nozzles of the second head block 202B from the ink ejection surface.

At step S206, when the start points of the wiping operations for the respective head blocks 202 have been calculated, preparatory steps are carried out in the respective sections of the inkjet recording apparatus 10 in order to start the maintenance operation for the first head block 202A (step S208).

After the preparatory steps in the respective sections have been completed in step S208 and the blade 66 has been moved to the ink ejection surface wiping start position for the head block 202A (in the vicinity of the left edge of the head 200 in FIG. 12; the position of the blade 66 shown in FIG. 12), the sub tank 208A of the head block 202A (the head block k=1) is raised to a position (hereinafter, also referred to as “non-ejection drive signal application position”) indicated by the reference numeral 240 and depicted by the dotted lines, and the internal pressure of the head block 202A is thereby changed to the positive pressure (step S210). Here, the position (height) of the sub tank 208 means the height (level) of the liquid inside the sub tank with respect to the ink ejection surface of the head 200.

The sub tank 208A is raised at the non-ejection drive signal application position 240, the internal pressure of the head block 202A is thereby maintained in a prescribed positive pressure state, and the non-ejection drive signal as shown in FIGS. 8A and 8B is applied to the piezoelectric elements corresponding to the nozzles of the head block 202A, during the established application time period T1 (step S212).

After the non-ejection drive signal is applied in step S212, the elapsed time T from the application end timing of the non-ejection drive signal is measured (step S214).

At step S214, if the elapsed time T from the application end timing of the non-ejection drive signal is less than the established standby duration (NO verdict), then the measurement of the elapsed time T from the application end timing of the non-ejection drive signal is continued. On the other hand, if the elapsed time T from the application end timing of the non-ejection drive signal is equal to or greater than the established standby duration (YES verdict), then the sub tank 208A is lowered from the non-ejection drive signal application position to the wiping position 242, and the internal pressure of the head block 202A is thereby changed from the positive pressure to the atmospheric pressure (step S216). At the wiping position 242 indicated by the solid lines in FIG. 12, the surface of the liquid inside the sub tank 208A is the same height as the ink ejection surface 216 of the head 200.

The sub tank 208A is held at the wiping position 242 shown in FIG. 12, and the wiping operation of the ink ejection surface 216A of the head block 202A is started by the blade 66 (step S218 in FIG. 13).

During the wiping operation of the ink ejection surface 216A of the head block 202A, the position of the blade 66 on the ink ejection surface of the head block 202A is determined, and it is judged whether or not the blade 66 passes by the head block 202A (step S220). While the blade 66 is positioned under the head block 202A (during wiping of the ink ejection surface 216 of the head block 202A) (NO verdict), the determination of the position of the blade 66 is continued. On the other hand, if the blade 66 has passed by the head block 202A and the wiping of the ink ejection surface 216 of the head block 202A has been completed (YES verdict), then the sub tank 208A is lowered from the wiping position 242 shown in FIG. 12 to the ejection standby position 244, and the internal pressure of the head block 202A is changed from the atmospheric pressure to the negative pressure, thereby completing the ink ejection surface maintenance control procedure of the first head block 202A (step S224).

Furthermore, when the wiping operation for the head block 202A by the blade 66 is started at step S218, the ink ejection surface maintenance control procedure for the next head block 202B (second head block; k=2) is started (step S230).

When the ink ejection surface maintenance control procedure is performed for the second and subsequent head blocks (i.e., k-th head blocks; k=2, 3, 4, . . . N), the internal pressure and the application of the non-ejection drive signal are controlled in such a manner that the ink will have spread over the ink ejection surface of the k-th head block before the blade 66 arrives at the wiping start position for the k-th head block.

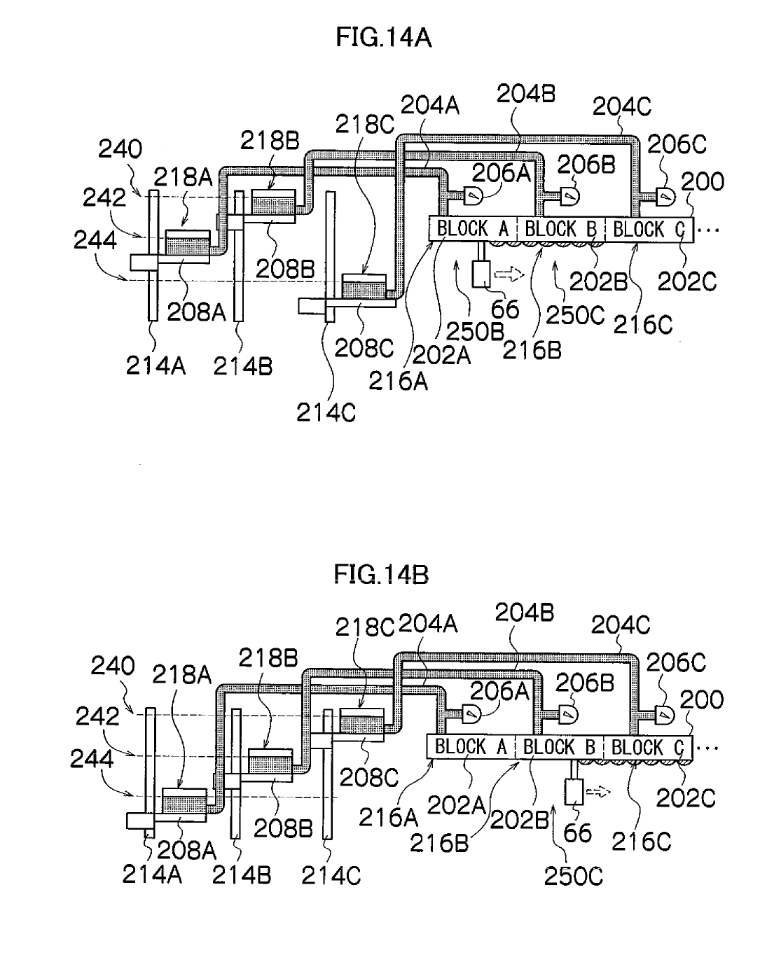

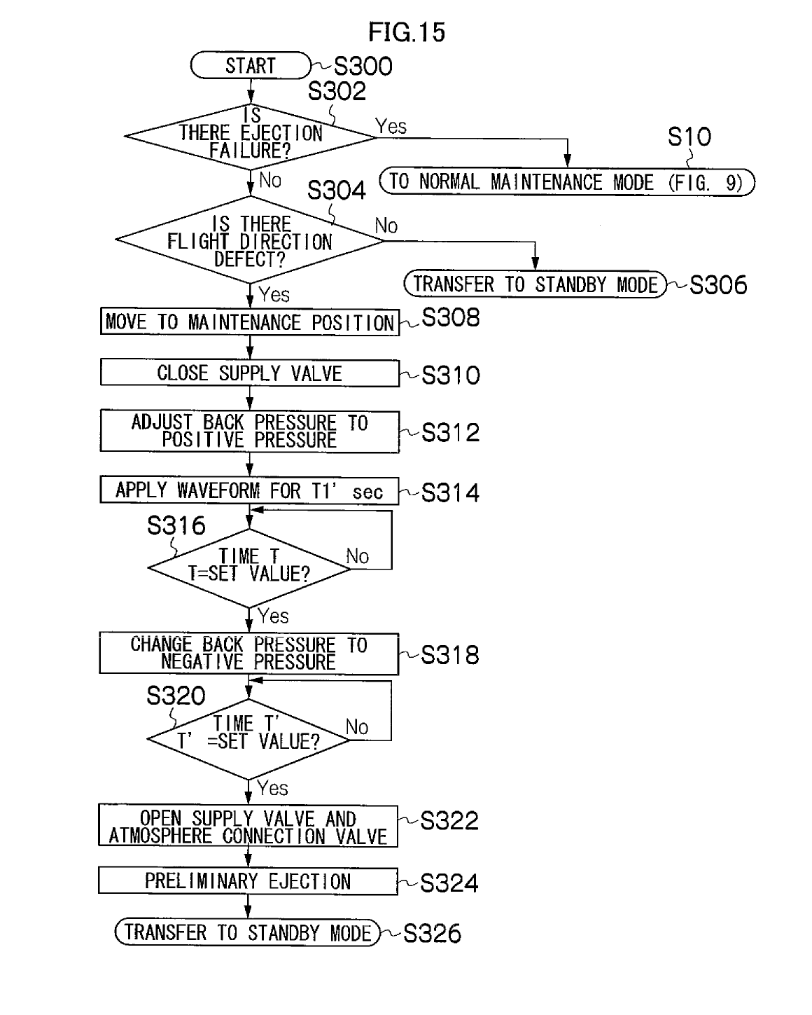

FIG. 14A is a diagram showing a state where the internal pressure of the next head block (i.e., (k+1)-th head block) 202B is changed during the wiping operation of the ink ejection surface 216A of the head block 202A. As shown in FIG. 14A, while the ink ejection surface 216 of the head block 202A is being wiped by the blade 66, in the head block 202B where an ink ejection surface wiping operation is to be carried out next, the internal pressure of the head block 202B is changed in order that ink is caused to bleed out from the nozzles 51 onto the ink ejection surface 216 and in order that the ink which has bled out from the nozzles 51 is caused to spread over the ink ejection surface 216, by the time that the blade 66 arrives at the wiping start position for that head block 202B.

In other words, it is judged whether or not the blade 66 has arrived at a position (internal pressure change start point) corresponding to the pressure change timing for one of the respective head blocks, which has been stored at step S206 in FIG. 13. If it is judged at step S206 that the blade 66 has arrived at the internal pressure change start point of a head block, then the internal pressure of that head block is changed from the negative pressure to the positive pressure, and the non-ejection drive signal is then applied to the piezoelectric elements of that head block.

The state shown in FIG. 14A indicates a state where the head block 202A is in the process of receiving a wiping operation by the blade 66 and the sub tank 208A of the head block 202A is positioned at the wiping position 242. Furthermore, since the blade 66 has passed by the position corresponding to the internal pressure change timing for the head block 202B, then the internal pressure of the head block 202B has been changed to the positive pressure and the non-ejection drive signal has been applied to the piezoelectric elements of the head block 202B, thereby causing ink to spread out over the ink ejection surface 216B of the head block 202B. The head block 202C still remains in the ejection standby state, and the sub tank 208C of the head block 202C is positioned at the ejection standby position 244 (i.e., the negative pressure is applied to the head block 202C).

In other words, during the wiping operation of the ink ejection surface 216A of the (k−1)-th head block 202A, the position of the blade 66 is determined and it is judged whether or not the blade 66 has been arrived at the internal pressure change start position for the k-th head block 202B (at step S232 in FIG. 13). In step S232, if it is judged that the blade 66 has not yet arrived at the internal pressure change start position for the k-th head block 202B (NO verdict), then the determination of the position of the blade 66 is continued. On the other hand, if it is judged that the blade 66 has arrived at the internal pressure change start position for the k-th head block 202B (YES verdict), then the internal pressure of the k-th head block is changed from the negative pressure to the positive pressure (step S234), and the non-ejection drive signal is then applied (step S236).

For example, as shown in FIG. 14A, when the blade 66 has passed by the internal pressure change start point 250B for the head block 202B, during the wiping operation of the ink ejection surface 216 of the head block 202A, then the sub tank 208B corresponding to the head block 202B is raised from the ejection standby position 244 to the non-ejection drive signal application position 240, thereby changing the internal pressure of the head block 202B to the positive pressure, and the non-ejection drive signal is then applied to the piezoelectric elements 58 corresponding to the nozzles of the head block 202B.

When the non-ejection drive signal has been applied for the established application time period T1 in the step S236 in FIG. 13, then the elapsed time T from the application end timing of the non-ejection drive signal is measured and it is judged whether or not the measured elapsed time T amounts to the predetermined standby duration (step S238). If the elapsed time T from the application end timing of the non-ejection drive signal is less than the established standby duration (NO verdict), then the measurement of the elapsed time T is continued. On the other hand, at step S238, if the elapsed time T from the application end timing of the non-ejection drive signal is equal to or greater than the established standby duration, in other words, if the blade 66 reaches the wiping operation start position of the head block 202B (YES verdict), the internal pressure of the k-th head block is changed from the positive pressure to the atmospheric pressure, and the wiping operation of the ink ejection surface 216 of the k-th head block is started by the blade 66 (step S240).

During the wiping operation of the ink ejection surface of the k-th head block, it is determined whether or not the blade 66 has passed by the k-th head block (step S242). In step S242, if it is judged that the blade 66 has not yet passed by the k-th head block (NO verdict), then the determination of the position of the blade 66 is continued. On the other hand, if the blade 66 has passed by the k-th head block (YES verdict), then the internal pressure of the k-th head block is changed from the atmospheric pressure to the negative pressure (step S244), and the ink ejection surface maintenance control procedure of the k-th head block terminates (step S246).

FIG. 14B is a diagram showing a state where the blade 66 has passed by the internal pressure change start point of the third head block 202C, during a wiping operation for the second head block 202B. When the blade 66 passes by the internal pressure change start position 250C of the third head block 202C during the wiping operation of the head block 202B as shown in FIG. 14B, then the sub tank 208C is raised to the non-ejection drive signal application position 240, and the internal pressure of the head block 202C is changed from the negative pressure to the positive pressure. In this state, the non-ejection drive signal is applied to the piezoelectric elements which correspond to the nozzles of the head block 202C, thereby causing the ink to bleed out from the nozzles 51 onto the ink ejection surface 216 of the head block 202C, as well as causing the ink that has bled out from the nozzles 51 to spread over the ink ejection surface 124.

Furthermore, at step S232, when the blade 66 arrives at the internal pressure change start position of the k-th head block, then it is judged whether or not the k-th head block is the last block, namely, the N-th block (step S260). If the k-th head block is not the N-th head block, then (k+1) is substituted for k (step S262), and the processes in step S232 to step S246 are repeated in respect of the (k+1)-th head block.

On the other hand, in step S260, if the k-th head block is the final head block, in other words, the N-th head block (YES verdict), then when the wiping operation of the N-th head block has been completed (step S264), the movement of the blade 66 is halted (step S266), and the blade 66 is withdrawn to a prescribed withdrawal position (step S268).

Thereupon, preliminary ejection is carried out for all of the head blocks (step S270), the maintenance mode is halted, and the procedure then transfers to the standby mode (step S272). In a mode where a cap is provided for each of the head blocks 202, it is possible to carry out preliminary ejection immediately after the completion of the wiping of the ink ejection surface 216 in each head block 202.

In the flowchart shown in FIG. 13, the cleaning mode judgment routine shown in FIG. 11 is omitted, but it is also possible to carry out the cleaning mode judgment routine as shown in FIG. 11 in the next step after the information acquisition step (step S204). In this case, although it is possible to set a common cleaning mode for all of the head blocks, the cleaning mode is preferably set independently for each of the head blocks.

In the inkjet recording apparatus having the composition described above, the head 200 is composed of a plurality of head blocks, and the changing of the internal pressure and the application of the non-ejection drive signal are controlled independently for each of the head blocks. Therefore, the power consumed when applying the non-ejection drive signal to the respective head blocks is lower than the power consumed when applying the non-ejection drive signal to the whole head (i.e., the head which is not divided into the head blocks). Consequently, the head driver which serves as a supply source for the non-ejection drive signal (reference numeral 84 in FIG. 6) can be made more compact in size.

The present embodiment has been described with reference to a mode in which the whole of the liquid ejection surface of the head 200 is wiped by moving the blade 66 at a uniform speed, without changing the operating speed of the blade 66. However, it is also possible to halt the blade 66 temporarily when the blade 66 is moved to a nozzle-free region of the liquid ejection surface, which is a region where nozzles are not provided. In this case, the nozzle-free region may be provided on the liquid ejection surface of the head 200 by arranging the nozzles in a staggered configuration, for example.

Furthermore, the present embodiment has been described with reference to a mode where the whole of the ink ejection surface 216 of the head 200 is wiped in one maintenance operation. However, a desirable mode is one in which it is judged whether or not wiping of the ink ejection surface 216 is necessary with respect to each of the respective head blocks, on the basis of the frequency of use information of the respective head blocks 202 acquired at step S204 in FIG. 13, and wiping of the ink ejection surface 216 is carried out for some of the head blocks, selectively.

### Third Embodiment

Next, a third embodiment of the present invention will be described. In the third embodiment, the same composition of the inkjet recording apparatus, head structure, composition of the ink supply system and overall system composition can be adopted as in the first embodiment, and therefore further explanation thereof is omitted here. For the control of the change of the internal pressure of the head (the composition of the head internal pressure control), it is possible to adopt either the mode described in the first embodiment or the mode described in the second embodiment.

In the third embodiment of the present invention, a composition is adopted in which the adhering material that is attached to the ink ejection surface is removed by a method other than wiping by the blade 66.

Problems regarding the deflection of the flight direction of the ink droplets ejected from the nozzles or the like may arise due to adherence of ink mist to the end faces of the nozzles (the edges of the nozzle openings). Apart from the adherence of ink mist to the end faces of nozzles, another possible cause of flight direction abnormalities including the bending of the flight direction of the ink droplets, is non-uniformity in the wetting properties at the periphery of the nozzle, due to the movement of the clip point which is caused by vibration of the meniscus.

By carrying out the maintenance indicated by the control sequence shown in FIG. 15, it is possible reliably to restore nozzles suffering such abnormalities in the flight direction of the ink droplets.

In other words, when the head maintenance described in the present embodiment is started (step S300), ejection abnormality determination is carried out and it is judged whether or not there are nozzles suffering ejection failures (step S302). If it is judged that there is an ejection failure nozzle at step S302 (YES verdict), then the processing transfers to the normal maintenance mode shown in FIG. 9, and a restoration operation is carried out in respect of the ejection failure nozzle.

If, on the other hand, it is judged at step S302 that there is no ejection failure nozzle (NO verdict), then the processing advances to step S304 and it is judged whether or not there is a nozzle that has been subjected to a flight direction abnormality. If it is judged that there is no nozzle subjected to the flight direction abnormality at step S304 (NO verdict), then the maintenance operation is terminated (step S306).

If, on the other hand, it is judged that there is a nozzle suffering a flight direction at step S304 (YES verdict), then the head is moved to the maintenance position (step S308), the supply valve 63 shown in FIG. 5 is closed (step S310 in FIG. 15), the internal pressure of the head is changed to the positive pressure (step S312), and the non-ejection drive signal shown in FIGS. 8A and 8B is applied to the piezoelectric elements (step S314). It is also possible to adopt a composition in which the maintenance member is moved to the position of the head, rather than moving the head to a maintenance position.

After the non-ejection drive signal has been applied to the piezoelectric elements for a period of T1′ at the step S314, the elapsed time from the application end timing of the non-ejection drive signal is measured (step S316). If it is judged that the elapsed time T from the application end timing of the non-ejection drive signal is less than the established standby duration (NO verdict), then the measurement of the elapsed time T from the application end timing of the non-ejection drive signal is continued. On the other hand, if it is judged that the elapsed time T from the application end timing of the non-ejection drive signal is equal to or greater than the established standby duration (YES verdict), then the internal pressure of the head is changed to the negative pressure (step S318).

In the restoration of a nozzle suffering the flight direction abnormality, it is necessary to improve the wetting properties slightly to the outside of the nozzle end face only, and therefore the elapsed time T from the application end timing of the non-ejection drive signal according to the present embodiment can be set to a sufficiently shorter time than the elapsed time T from the application end timing of the non-ejection drive signal stated in the first embodiment or the second embodiment described above; namely, it can be set to 1 second through 2 seconds, for instance. Consequently, the elapsed time T from the application end timing of the non-ejection drive signal according to the present embodiment is set to 1 second.

Furthermore, by changing the internal pressure of the head from the positive pressure to the negative pressure, the ink which has wet and spread over the ink ejection surface is caused to move inside the nozzles, and by controlling the internal pressure of the head in such a manner that this state of negative pressure inside the head is maintained for a prescribed period of time, the ink which has wet and spread over the ink ejection surface is recovered completely into the nozzles.

At step S320, the elapsed time T′ from the timing at which the internal pressure of the head changed from the positive pressure to the negative pressure is measured and it is judged that the elapsed time T′ amounts to the prescribed standby duration. If it is judged that the elapsed time T′ from the timing at which the internal pressure of the head has been changed from the positive pressure to the negative pressure is less than the established standby duration (NO verdict), then the measurement of the elapsed time T′ from the timing at which the internal pressure of the head has been changed from the positive pressure to the negative pressure is continued. On the other hand, if the elapsed time T′ from the timing at which the internal pressure of the head has been changed from the positive pressure to the negative pressure is equal to or greater than the established time (YES verdict), then the supply valve 63 and the atmosphere connection valve 106 in FIG. 5 are opened (step S322), and the internal pressure of the head is thereby changed to atmospheric pressure. In this state, a preliminary ejection is performed (step S324).

When the preliminary ejection has been completed in step S324, the maintenance procedure terminates (step S326).

In the present embodiment, the elapsed time T from the application end timing of the non-ejection drive signal is shorter than in a mode where a wiping operation is performed on the ink ejection surface by means of a blade, and therefore the region over which the ink wets and spreads on the ink ejection surface is smaller than in a mode where an ink ejection surface wiping operation is performed by means of a blade; for example, even in a case where nozzles which eject inks of different colors are formed on the same ink ejection surface, it is still possible to carry out maintenance without the occurrence of color mixing on the ink ejection surface.

By setting the elapsed time T′ from the timing at which the internal pressure of the head has been changed from the positive pressure to the negative pressure, the ink which has wet and spread slightly over the ink ejection surface is suctioned back into the head. By making the elapsed time T′ from the timing at which the internal pressure of the head has been changed from the positive pressure to the negative pressure longer than the elapsed time T from the application end timing of the non-ejection drive signal (T′>T), it is possible to make the ink that has wet and spread over the ink ejection surface return reliably into the head

Furthermore, the amount of ink that spreads over the ink ejection surface is extremely small compared to a mode where an ink ejection surface wiping operation is carried out by a means of a blade, and therefore the ink which spreads over the ink ejection surface does not make contact with adhering material that is attached to distant positions. Even supposing that the ink spreading over the ink ejection surface does make contact with adhering material that is attached to distant positions, since the amount of ink is extremely small, then dirt, and the like, does not float up into the ink, and hence there is no infiltration of dirt, or the like, into the head when the ink that has wet and spread over the ink ejection surface returns into the head. The non-ejection drive signal waveform application time T1′ is set to 0.1 seconds in the present embodiment.

Moreover, it is possible to remove ink mist that is attached to the end faces of the nozzles and which gives rise to flight direction abnormalities, without using a wiping member such as a blade. Since the wiping operation by the blade can be omitted, then it is possible to shorten the maintenance time.

According to the third embodiment of the present invention, the object is to improve the direction of ejection of the ink by altering the wetting properties in the vicinity of the nozzles. On the other hand, in the invention relating to the related art (for example, Japanese Patent Application Publication No. 7-096604), the object is to remove an ink film on the front surface of the head. Furthermore, one of the characteristic features of the third embodiment described above relates to the control for recovering the ink that has bled out onto the ink ejection surface, back into the nozzles (namely, a timer is provided for measuring the elapsed time T from the application end timing of the non-ejection drive signal, and so on). On the other hand, in the invention described in Japanese Patent Application Publication No. 7-096604, the ink which has bled out from the nozzles is wiped away.

In the first to third embodiments described above, an inkjet recording apparatus 10 forms a color image on recording paper 16 by ejecting colored inks onto the recording paper 16. However, the present invention can also be applied broadly to liquid ejection apparatuses which form a desired image or pattern on a medium, such as a metal sheet, a resin sheet, a printed circuit substrate, or a silicon wafer, by ejecting liquid such as an image forming body, a resist, a liquid chemical, or the like.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A liquid ejection apparatus, comprising:
a liquid ejection head which includes a nozzle ejecting liquid, a pressure chamber connected to the nozzle and arranged in a liquid ejection surface of the liquid ejection head, and a pressure application device applying pressure to the liquid inside the pressure chamber,
an internal pressure adjustment device which adjusts an internal pressure of the liquid ejection head; and
a pressure control device which controls the internal pressure adjustment device and the pressure application device so as to spread the liquid over the liquid ejection surface of the liquid ejection head, wherein:
the internal pressure adjustment device adjusts the internal pressure of the liquid ejection head to a positive pressure so as to still hold the liquid on the nozzle while protruding the liquid from the liquid ejection surface;
the pressure application device then applies the pressure to the liquid inside the pressure chamber for a pressure application duration so as not to cause the liquid to be ejected from the nozzle but to flow out the liquid from the nozzle onto the liquid ejection surface, while the internal pressure adjustment device is adjusting the internal pressure to the positive pressure; and
the pressure application device then stops applying the pressure to the liquid inside the pressure chamber after the pressure application duration, while the internal pressure adjustment device is adjusting the internal pressure to the positive pressure.

2. The liquid ejection apparatus as defined in claim 1, wherein the pressure application duration is not less than 0.1 seconds and less than 10 seconds.

3. The liquid ejection apparatus as defined in claim 1, further comprising:
an information acquisition device which acquires information including at least one of a type of the liquid, use frequency of the liquid ejection head, temperature of the liquid ejection head, and ambient humidity; and
a viscosity judgment device which judges whether or not a viscosity of the liquid inside the liquid ejection head is higher than a reference viscosity, in accordance with the information acquired by the information acquisition device,
wherein when the viscosity judgment device judges that the viscosity in the liquid ejection head is higher than the reference viscosity, the pressure control device increases the pressure application duration.

4. The liquid ejection apparatus as defined in claim 1, further comprising a liquid collection device which collects the liquid that has been spread over the liquid ejection surface.

5. The liquid ejection apparatus as defined in claim 4, further comprising:
a standby duration setting device which sets a standby duration; and
a measurement device which measures an elapsed time from a time when the pressure application device stops applying the pressure to the liquid inside the pressure chamber, wherein:
the liquid collection device includes a wiping member which makes contact with the liquid ejection surface while wiping the liquid ejection surface;
the pressure control device controls the internal pressure adjustment device to change the internal pressure of the liquid ejection head from the positive pressure to an atmospheric pressure, when the elapsed time measured by the measurement device reaches the standby duration set by the standby duration setting device; and
the wiping device wipes and removes from the liquid ejection surface the liquid that has been spread over the liquid ejection surface, while the internal pressure adjustment device is adjusting the internal pressure of the liquid ejection head to the atmospheric pressure.

6. The liquid ejection apparatus as defined in claim 1, further comprising:
a standby duration setting device which sets a standby duration; and
a measurement device which measures an elapsed time from a time when the pressure application device stops applying the pressure to the liquid inside the pressure chamber,
wherein the pressure control device controls the internal pressure adjustment device to change the internal pressure of the liquid ejection head from the positive pressure to a negative pressure so that the liquid having been spread over the liquid ejection surface is collected into the nozzle, when the elapsed time measured by the measurement device reaches the standby duration set by the standby duration setting device,

7. The liquid ejection apparatus as defined in claim 1, wherein:
the liquid ejection head includes at least two nozzle blocks each having at least one nozzle;
the internal pressure adjustment device is provided for each of the at least two nozzle blocks; and
the pressure control device controls the internal pressure adjustment device and the pressure application device for each of the at least two nozzle blocks so that the liquid is flowed out onto the liquid ejection surface from the at least one nozzle, and the liquid is then spread over the liquid ejection surface.

8. A liquid ejection surface maintenance method of maintaining a liquid ejection surface of a liquid ejection head which includes: a nozzle ejecting liquid and a pressure chamber connected to the nozzle, the liquid ejection surface maintenance method comprising the steps of:
adjusting an internal pressure of the liquid ejection head to a positive pressure so as to still hold the liquid on the nozzle while protruding the liquid from the liquid ejection surface;
then applying pressure to the liquid inside the pressure chamber for a pressure application duration so as not to cause the liquid to be ejected from the nozzle but to flow out the liquid from the nozzle onto the liquid ejection surface, while the internal pressure is being adjusted to the positive pressure; and
then stopping applying the pressure to the liquid inside the pressure chamber after the pressure application duration, while the internal pressure is being adjusted to the positive pressure,
wherein the liquid is thereby spread over the liquid ejection surface.

9. The liquid ejection surface maintenance method as defined in claim 8, further comprising the steps of:
setting a standby duration;
measuring an elapsed time from a time when application of the pressure to the liquid inside the pressure chamber is stopped;
changing the internal pressure of the liquid ejection head from the positive pressure to an atmospheric pressure, when the measured elapsed time reaches the set standby duration; and
wiping and removing from the liquid ejection surface the liquid that has been spread over the liquid ejection surface, while the internal pressure of the liquid ejection head is being adjusted to the atmospheric pressure.

10. The liquid ejection surface maintenance method as defined in claim 8, further comprising the steps of:
setting a standby duration;
measuring an elapsed time from a time when application of the pressure to the liquid inside the pressure chamber is stopped; and
changing the internal pressure of the liquid ejection head from the positive pressure to a negative pressure so that the liquid having been spread over the liquid ejection surface is collected into the nozzle, when the measured elapsed time reaches the set standby duration.
